(19) United States
(12) Patent Application Publication
(10) Pub. No.: US 2024/0210916 A1
(43) Pub. Date: Jun. 27, 2024

(54) MACHINE AND DEEP LEARNING TECHNIQUES FOR PREDICTING ECOLOGICAL EFFICIENCY IN SUBSTRATE PROCESSING

(71) Applicant: APPLIED MATERIALS, INC., Santa Clara, CA (US)

(72) Inventors: Orlando Trejo, Livermore, CA (US); Ala Moradian, San Jose, CA (US); Elizabeth Neville, Redwood City, CA (US); Umesh Madhav Kelkar, Cupertino, CA (US); Satomi Murayama, Sunnyvale, CA (US)

(21) Appl. No.: 18/087,641

(22) Filed: Dec. 22, 2022

(51) Int. Cl. G05B 19/4155; G06N 5/022

(52) U.S. Cl. CPC G05B 19/4155; G06N 5/022; G05B 2219/45031

(57) ABSTRACT

In some embodiments, a method includes receiving a process recipe including process recipe setpoint data. The method further includes inputting the process recipe into one or more trained machine learning models that output predicted environmental resource usage data indicative of an environmental resource consumption associated with processing a substrate in a process chamber according to the process recipe. The method further includes outputting a recommendation associated with the process recipe based at least in part on the predicted environmental resource usage data.

### TECHNICAL FIELD

The instant specification generally relates to environmental impact of manufacturing equipment such as semiconductor manufacturing equipment. More specifically, the instant specification relates to machine and deep learning techniques for predicting ecological efficiency in substrate processing.

### BACKGROUND

The continued demand for electronic devices calls for an increasingly larger demand for semiconductor wafers. The increase in manufacturing to produce these wafers takes a substantial toll on the environment in the form of resource utilization and the creation of environmentally damaging waste. Thus, there is an increased demand for more ecologically-friendly and environmentally responsible methods of wafer manufacture and of manufacturing in general. Given that wafer processing is energy intensive, there is value in decoupling the semiconductor industry's growth from its environmental impact. Growing chip demand and increasing chip complexity is increasing the environmentally impacting resource consumption. Further, increasing chip complexity increases the difficulty in determining eco-efficient substrate processing recipes.

### SUMMARY

The following is a simplified summary of the disclosure in order to provide a basic understanding of some aspects of the disclosure. This summary is not an extensive overview of the disclosure. It is not intended to delineate any scope of the particular implementations of the disclosure or any scope of the claims. Its sole purpose is to present some concepts of the disclosure in a simplified form as a prelude to the more detailed description that is presented later.

In some embodiments, a method includes receiving a process recipe including process recipe setpoint data. The method further includes inputting the process recipe into one or more trained machine learning models that output predicted environmental resource usage data indicative of an environmental resource consumption associated with processing a substrate in a process chamber according to the process recipe. The method further includes outputting a recommendation associated with the process recipe based at least in part on the predicted environmental resource usage data.

In some embodiments, a system includes one or more process chambers configured to process substrate. The one or more chambers include a plurality of sensors. The system further includes a system controller to control the one or more process chambers. The system controller is to receive a process recipe including process recipe setpoint data. The system controller is further to input the process recipe into one or more trained machine learning models that output predicted environmental resource usage data indicative of an environmental resource consumption associated with processing a substrate in a process chamber according to the process recipe. The system controller is further to output a recommendation associated with the process recipe based at least in part on the predicted environmental resource usage data.

In some embodiments, a non-transitory machine-readable storage medium includes instructions that, when executed by a processing device, cause the processing device to train a first machine learning model to form a first trained machine learning model. The first trained machine learning model is trained to output predicted measurement data based on a process recipe input into the first trained machine learning model. The processing device is further to train a second machine learning model with training data including the predicted measurement data output from the first trained machine learning model to form a second trained machine learning model. The second trained machine learning model is trained to output predicted environmental resource usage data indicative of an environmental resource consumption associated with processing a substrate in a process chamber according to the first process recipe input into the second trained machine learning model.

### BRIEF DESCRIPTION OF THE DRAWINGS

Aspects and implementations of the present disclosure will be understood more fully from the detailed description given below and from the accompanying drawings, which are intended to illustrate aspects and implementations by way of example and not limitation.

FIG. 1 is a top schematic view of an example manufacturing system, according to one embodiment.

FIG. 2A is a block diagram illustrating a logical view of an exemplary eco-efficiency platform, according to one embodiment.

FIG. 2B is a simplified block diagram illustrating a logical view of an exemplary eco-efficiency prediction platform in accordance with some implementations of the present disclosure.

FIG. 3 is a block diagram illustrating an exemplary system architecture in which implementations of the disclosure may operate.

FIG. 4 depicts an exemplary digital replica, in accordance with some implementations of the present disclosure.

FIG. 5 is an exemplary illustration of a process parameter value window, in accordance with some implementation of the present disclosure.

FIG. 6 is a flow chart of a method for generating a training dataset for training a machine learning model, according to aspects of the present disclosure.

FIG. 7 illustrates a flow diagram for a method of training a machine learning model to determine a predicted cooling parameter value, in accordance with aspects of the present disclosure.

FIG. 8A is a flow diagram of a method for obtaining a recommendation for processing a substrate, in accordance with some implementations of the present disclosure.

FIG. 8B is a flow diagram of a method for obtaining predicted process recipe setpoint data, in accordance with some implementations of the present disclosure.

FIG. 8C is a flow diagram of a method for obtaining predicted environmental resource usage data, in accordance with some implementations of the present disclosure.

FIG. 9A illustrates a chart showing predicted environmental resource consumption data with respect to observed environmental resource consumption, in accordance with some implementations of the present disclosure.

FIG. 9B illustrates a chart showing predicted or actual time series environmental resource consumption data, in accordance with some implementations of the present disclosure.

FIG. 10 depicts a block diagram of an example computing device, operating in accordance with one or more aspects of the present disclosure.

### DETAILED DESCRIPTION

Ecological-efficiency (eco-efficiency) characterization is a complex technique used to determine different levels of inputs (e.g., resources, utilization, etc.) associated with a particular manufacturing tool during use of the tool. Eco-efficient characterization is used to determine how changing inputs impact eco-efficiency of the manufacturing tool. Eco-efficiency characterization and/or eco-efficiency prediction may be beneficial during development of a manufacturing tool to help develop manufacturing tools that maximize a per-unit (or per-time) eco-efficiency and minimize harmful environmental impact. Eco-efficiency characterization may also be beneficial after tool development, while the tool is operational, to fine tune the per-unit eco-efficiency characteristics of the tool and/or of process recipes in view of the specific parameters according to which the tool is operating.

Embodiments described herein provide a system for predicting and optimizing eco-efficiency for a substrate process recipe throughout design, development, and implementation of that process recipe. In some embodiments, methods disclosed herein are capable of assisting engineers in developing, optimizing, and/or operating processes that meet both material engineering and eco-efficiency specifications. In some embodiments, sensor data and/or models are leveraged to provide predictions of the eco-efficiency of numerous manufacturing systems, individual process chambers of those manufacturing systems, and/or particular process recipes performed in the individual process chambers. Additionally, the methods described herein may enable the optimization of process recipes to increase eco-efficiency, while maintaining processed substrate targets. For example, using an output of a predictive model as an indicator of environmental resource usage, process recipes can be chosen and/or optimized to reduce the consumption of environmental resources while still meeting set substrate target results. According to some implementations described herein, the optimization and/or choosing of process recipes to increase eco-efficiency can be accomplished prior to actual implementation of the process recipe. For example, using historical data, models can be developed and leveraged to determine the eco-efficiency of a process recipe that is under development. In some embodiments, comparisons of the eco-efficiencies of several process recipes can be made and the process recipe with the greatest eco-efficiency that still meets manufacturing targets may be selected. Thus, eco-efficiency and/or environmental impact of substrate process recipes can be predicted and/or improved without physical testing or empirical results.

In some embodiments, an eco-efficiency prediction platform (e.g., software of a system controller) can receive a process (e.g., process recipe setpoint data) and sensor data to form eco-efficiency predictions. The process recipe and/or the sensor data may be input into one or more models such as one or more trained machine learning models, physics-based models (e.g., digital twins) and/or one or more additional models. In some embodiments, the process recipe is determined by a first model (e.g., a first predictive model, a trained machine learning model, etc.) based on processed substrate targets that are input into the model. For example, a user (e.g., an engineer, a technician, etc.) can input target process results (e.g., for a processed substrate) into the model. The first model may be trained to output possible process recipes for processing a substrate, where the output process recipes each meet the target process results. Because there may be many ways of achieving the target results (e.g., many recipes can produce a substrate meeting the target), the first model may output multiple different process recipes, each recipe meeting the target results.

Each of the output recipes that are output by the model may be input into a second model (e.g., a second predictive model, a second trained machine learning model, etc.) that is configured to predict eco-efficiencies associated input process recipes. Predicted eco-efficiency data corresponding to each of the process recipes may be output by the second model. Predicted eco-efficiency values can include predicted environmental resource usage data indicative of environmental resource consumption (e.g., consumption of chemicals, gases, power, water, and so on). As used herein, environmental resource usage data may include data on consumption of resources and/or chemicals, environmental impact of resource(s) and/or chemical(s) used/consumed, energy consumption, and/or environmental impact of energy consumed. In some examples, the predicted data includes time series data that indicates power consumption and/or flows of gasses associated with a process recipe. Each of the predicted eco-efficiency data may be analyzed and/or compared to determine the most eco-efficient process recipe (e.g., process recipe that consumes the least resources).

In some embodiments, a recommendation for processing a substrate is output based on the eco-efficiency data corresponding to the process recipes. The recommendation may indicate that a particular process recipe is to be implemented for processing substrates to meet the process targets. In some embodiments, the recommendation may include a modification to one or more process recipes and/or one or more additional targets and/or constraints for process recipes to increase their respective eco-efficiencies. The recommendation can be input into the first model (to predict process recipes), which may output further predicted or recommended process recipes. These further process recipes may be processed by the second model to determine resource consumption and/or eco-efficiency values for the further process recipes. Analysis may again be performed of the further recipes in view of the eco-efficiency values associated with these recipes to provide further recommendations. This process may be repeated so that the models working together can converge on a most eco-efficient process recipe that meets product targets.

In some embodiments, eco-efficiency is calculated on a per-unit basis. Typically, per-unit eco-efficiency is not taken into account in the manufacturing tool and/or process recipe development process. Additionally, it can be a cumbersome and complicated process to characterize per-unit eco-efficiency to adjust settings on a manufacturing tool or a process recipe while that tool is in use (e.g., while a tool is used for substrate production). Furthermore, prior solutions used special eco-efficiency training of people and specialized engineers and analysts for eco-efficiency characterization analysis. Embodiments of the present disclosure provide improved methods, systems and software for eco-efficiency characterization on a per-unit basis. These methods, systems and software may be used by individuals who have not received special eco-efficiency training.

In some embodiments, eco-efficiency characterization and/or prediction may be performed by a software tool in all stages of a manufacturing equipment lifecycle, including during the design stages and the operational stages of manufacturing equipment. Eco-efficiency may include the amount of environmental resource (e.g., electrical energy, water, gas, chemical, etc.) consumed per-unit of equipment production (e.g., per wafer, or per device manufactured). Eco-efficiency may also be characterized as the amount of environmental impact (e.g., CO₂ emissions, heavy metal waste, etc.) generated per-unit of equipment production.

Per-unit analysis, where a unit is any measurable quantity (e.g., a substrate, die, area (cm²), time period, device, etc.) operated on by a manufacturing tool, allows for more precise characterizations of eco-efficiency. Eco-efficiency on a “per-unit” basis allows for an accurate determination of resource usage and environmental impact per-unit produced, and can be easily manipulated as a measure of value. For example, it may be determined that a particular manufacturing tool has an electrical energy per-substrate-pass eco-efficiency rating of 1.0-2.0 kWh per-substrate-pass (in other embodiments eco-efficiency ratings may be less than 0.5 kWh, up to 20 kWh, or even greater than 20 kWh per-substrate-pass), indicating that each substrate operated on by the manufacturing tool may use, for example, 1.0-2.0 kWh of electrical energy per substrate processed. In other embodiments various other amounts of electrical energy may be used. Determining eco-efficiency on a per-substrate-pass basis allows for easy comparison with other manufacturing tools that have a different yearly electrical energy consumption value due to variance in yearly substrate throughput. In one embodiment, eco-efficiency may also be determined on a per-device basis by dividing a per-substrate eco-efficiency characterization by the number of devices per wafer.

Eco-efficiency characterization or calculation may be performed on manufacturing equipment and/or process recipes during operation. The manufacturing equipment may access real-time variables, such as utilization and utility use data of the equipment from first sensors on the manufacturing equipment and second sensors that are external sensors and that are not components of the manufacturing equipment, and use the real-time variables in one or more eco-efficiency model. Manufacturing equipment may fine-tune settings on the equipment to maximize eco-efficiency in view of the current operating conditions of the manufacturing equipment. Similarly, the sensor data (e.g., from the first sensors and/or the second sensors) can be input into a model (e.g., a trained machine learning model, a deep learning model, etc.), along with process recipe data (e.g., process recipe setpoint data) for the model to predict eco-efficiency data corresponding to the process recipe. In some embodiments, the sensor data is input into the model to inform the model of physical constraints (e.g., the physically constrain the model, to form a physics-informed model, etc.).

In some embodiments, a modification to a fabrication process (e.g., a subset of the process or multiple processes, a process recipe operation, etc.) may be determined based on environmental resource usage data or eco-efficiency characterization and/or prediction. For example, based on predicted environmental resource usage data for multiple process recipes output from a model, one or more modifications to process recipe parameters (e.g., setpoints) of a particular recipe can be determined. The modification to the process recipe parameters may be associated with improving an eco-efficiency of a selection of a manufacturing process (e.g., reducing an environmental resource consumption and/or environmental impact).

In some embodiments, eco-efficiency is based on resource consumption such as energy consumption, chemical consumption (e.g., gases such as hydrogen, nitrogen, chemicals used for etching or deposition of thin films and/or liquids that can be vaporized, atomized, or converted to a gaseous state via a bubbler, injector or atomizer), CDA (clean dry air)), and/or water consumption (such as process cooling water (PCW), de-ionized water (DIW), and ultrapure water (UPW), for example. However in some embodiments, the eco-efficiency is based on life-cycle data of a component associated with the manufacturing equipment. For example, an environmental resource consumption and/or environmental impact associated with the eco-efficiency characterization may be associated with a replacement procedure or an upkeep procedure of a consumable part of the manufacturing equipment. However, it should be understood that such embodiments also apply to consumption of chemicals having other states, such as chemicals in a liquid state. Any embodiments discussed herein with reference to gas consumption equally apply to consumption of other types of chemicals, such as liquids.

As described above, in some embodiments an eco-efficiency prediction platform predicts environmental resource usage of a process chamber that executes a fabrication process according to a process recipe based on predicted process recipe data, sensor data, and/or substrate process targets. By predicting eco-efficiency based on process targets and/or sensor data (e.g., sensor data used to inform the model), the predicted amount of resources used for a process in a process chamber can be more accurately determined. The improved accuracy of the eco-efficiency prediction platform that uses such data can result in better process development and lower overall resource consumption in some embodiments.

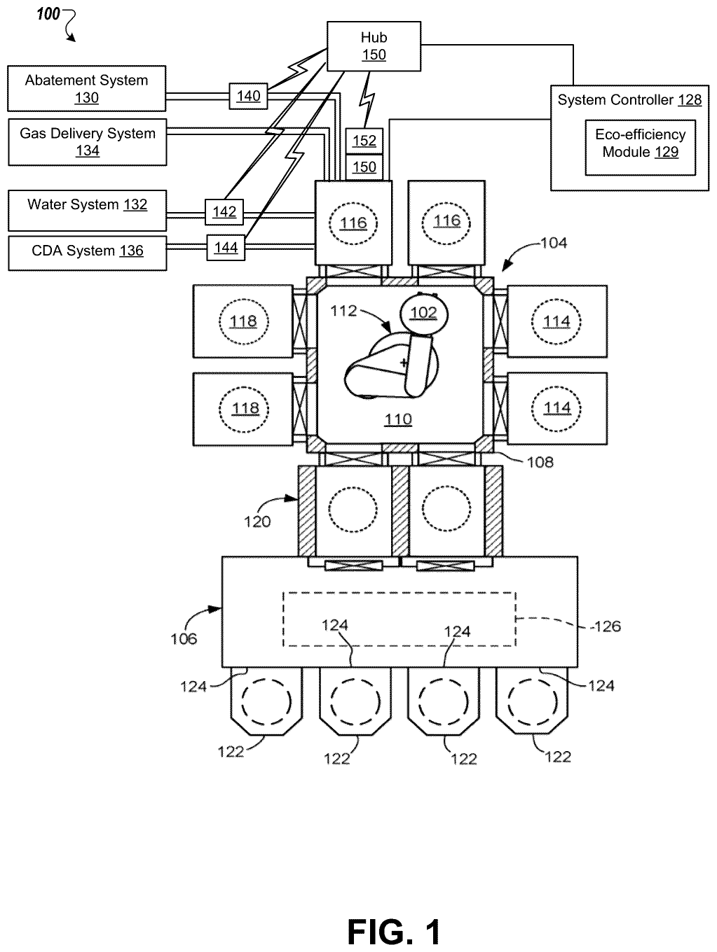

FIG. 1 is a top schematic view of an example processing system 100 (also referred to herein as a manufacturing system), according to one embodiment. In some embodiments, processing system 100 may be an electronics processing system configured to perform one or more processes on a substrate 102. In some embodiments, processing system 100 may be an electronics device manufacturing system. Substrate 102 can be any suitably rigid, fixed-dimension, planar article, such as, e.g., a silicon-containing disc or wafer, a patterned wafer, a glass plate, or the like, suitable for fabricating electronic devices or circuit components thereon. In some embodiments, processing system 100 is a semiconductor processing system. Alternatively, processing system 100 may be configured to process other types of devices, such as display devices.

Processing system 100 includes a process tool 104 (e.g., a mainframe) and a factory interface 106 coupled to process tool 104. Process tool 104 includes a housing 108 having a transfer chamber 110 therein. Transfer chamber 110 includes one or more processing chambers (also referred to as process chambers) 114, 116, 118 disposed therearound and coupled thereto. Processing chambers 114, 116, 118 can be coupled to transfer chamber 110 through respective ports, such as slit valves or the like. Processing chambers 114, 116, 118 can be configured to process substrates.

Processing chambers 114, 116, 118 can be adapted to carry out any number of processes on substrates 102. A same or different substrate process can take place in each processing chamber 114, 116, 118. Examples of substrate processes include atomic layer deposition (ALD), physical vapor deposition (PVD), chemical vapor deposition (CVD), etching, annealing, curing, pre-cleaning, metal or metal oxide removal, or the like. In one example, a PVD process is performed in one or both of process chambers 114, an etching process is performed in one or both of process chambers 116, and an annealing process is performed in one or both of process chambers 118. Other processes can be carried out on substrates therein. Processing chambers 114, 116, 118 can each include a substrate support assembly. The substrate support assembly can be configured to hold a substrate in place while a substrate process is performed.

Transfer chamber 110 also includes a transfer chamber robot 112. Transfer chamber robot 112 can include one or multiple arms, where each arm includes one or more end effectors at the end of the arm. The end effector can be configured to handle particular objects, such as wafers. In some embodiments, transfer chamber robot 112 is a selective compliance assembly robot arm (SCARA) robot, such as a 2 link SCARA robot, a 3 link SCARA robot, a 4 link SCARA robot, and so on.

A load lock 120 can also be coupled to housing 108 and transfer chamber 110. Load lock 120 can be configured to interface with, and be coupled to, transfer chamber 110 on one side and factory interface 106 on another side. Load lock 120 can have an environmentally-controlled atmosphere that is changed from a vacuum environment (where substrates are transferred to and from transfer chamber 110) to at or near an atmospheric-pressure inert-gas environment (where substrates are transferred to and from factory interface 106) in some embodiments. In some embodiments, load lock 120 is a stacked load lock having a pair of upper interior chambers and a pair of lower interior chambers that are located at different vertical levels (e.g., one above another). In some embodiments, the pair of upper interior chambers are configured to receive processed substrates from transfer chamber 110 for removal from process tool 104, while the pair of lower interior chambers are configured to receive substrates from factory interface 106 for processing in process tool 104. In some embodiments, load lock 120 are configured to perform a substrate process (e.g., an etch or a pre-clean) on one or more substrates 102 received therein.

Factory interface 106 can be any suitable enclosure, such as, e.g., an Equipment Front End Module (EFEM). Factory interface 106 can be configured to receive substrates 102 from substrate carriers 122 (e.g., Front Opening Unified Pods (FOUPs)) docked at various load ports 124 of factory interface 106. A factory interface robot 126 (shown dotted) can be configured to transfer substrates 102 between substrate carriers 122 (also referred to as containers) and load lock 120. In other and/or similar embodiments, factory interface 106 is configured to receive replacement parts from replacement parts storage containers 123. Factory interface robot 126 can include one or more robot arms and can be or include a SCARA robot. In some embodiments, factory interface robot 126 has more links and/or more degrees of freedom than transfer chamber robot 112. Factory interface robot 126 can include an end effector on an end of each robot arm. The end effector can be configured to pick up and handle specific objects, such as wafers. Alternatively, or additionally, the end effector can be configured to handle objects such as process kit rings.

Any conventional robot type can be used for factory interface robot 126. Transfers can be carried out in any order or direction. Factory interface 106 can be maintained in, e.g., a slightly positive-pressure non-reactive gas environment (using, e.g., nitrogen as the non-reactive gas) in some embodiments.

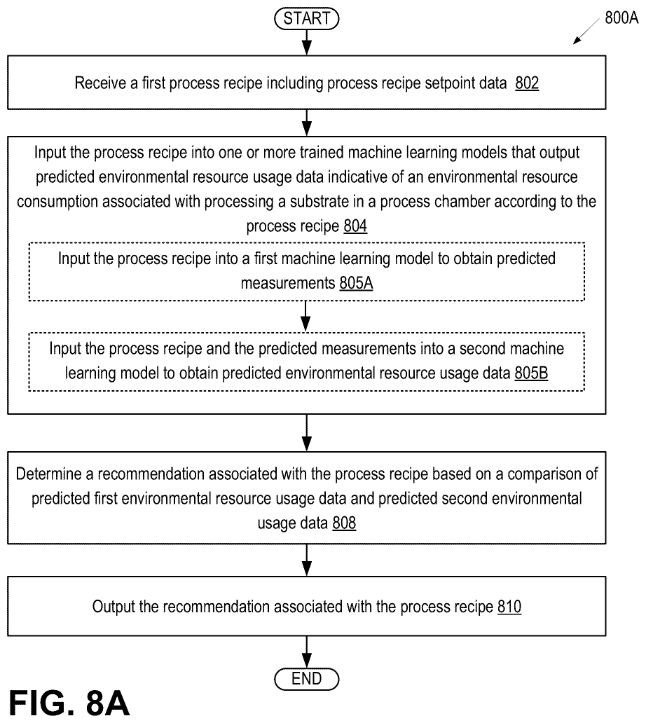

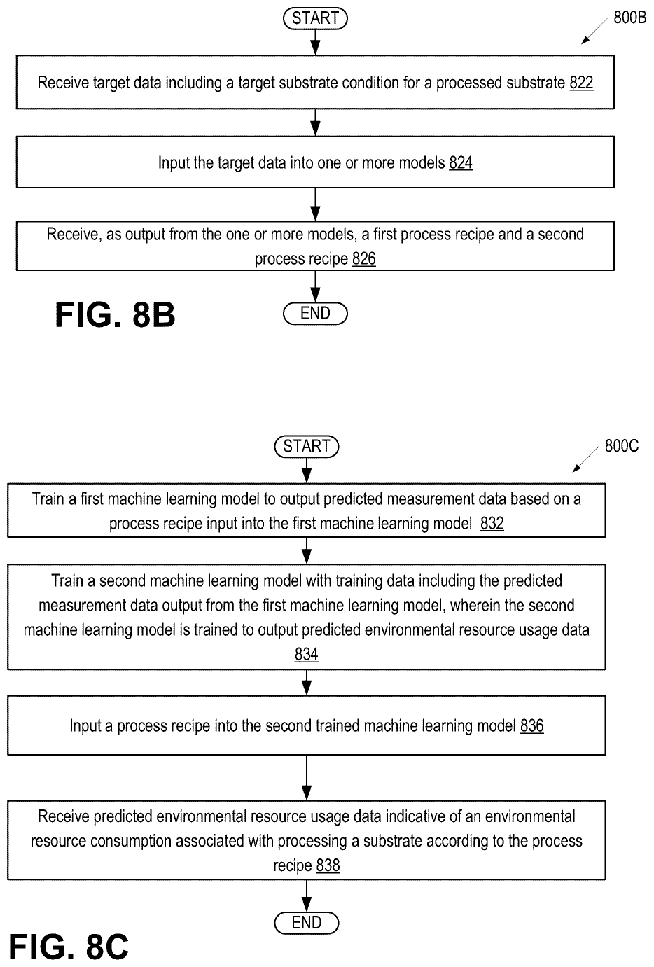

Processing system 100 can also include a system controller 128. System controller 128 can be and/or include a computing device such as a personal computer, a server computer, a programmable logic controller (PLC), a microcontroller, and so on. System controller 128 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 128 can include a data storage device (e.g., one or more disk drives and/or solid state drives), a main memory, a static memory, a network interface, and/or other components. System controller 128 can execute instructions to perform any one or more of the methodologies and/or embodiments described herein. The instructions can be stored on a computer readable storage medium, which can include the main memory, static memory, secondary storage and/or processing device (during execution of the instructions). In embodiments, execution of the instructions by system controller 128 causes system controller to perform the methods of FIGS. 8A and 8B. System controller 128 can also be configured to permit entry and display of data, operating commands, and the like by a human operator.

In some embodiments, system controller 128 includes an eco-efficiency module 129, which may be a local server that executes on the system controller 128 of the processing system 100. The eco-efficiency module 129 may be responsible for processing first sensor data generated by sensors of one or more processing chambers 114, 116, 118 as well as second sensor data from additional sensors 140, 142, 144 that are external to the processing chamber 114, 116, 118. The first sensor data may be generated by sensors that are integral to the processing chamber 114, 116, 118. Such sensors may include, for example, temperature sensors, power sensors, current sensors, pressure sensors, concentration sensors, and so on. The first sensor data output by the integral sensors of the processing chambers 114, 116, 118 may include measurements of current, voltage, power, flow (e.g., of one or more gases, CDA, water, etc.), pressure, concentration (e.g., of one or more gases), speed (e.g., of one or more moving parts, of gases, etc.), acceleration (e.g., of one or more moving parts, of gases, etc.), or temperature (e.g., of a substrate under process, of different locations in a processing chamber, and so on). In one embodiment, each chamber includes between about 20 to about 100 sensors.

In order to capture additional data not generally accessible by the integral sensors of the processing chambers 114, 116, 118, one or more external sensors 140, 142, 144, 152 may be attached to the processing chambers 114, 116, 118 and/or to feeds into and/or out of the processing chambers 114, 116, 118 and/or to sub-components that operate for the benefit of the processing chambers 114, 116, 118 (e.g., such as pumps and/or abatement systems). In one embodiment, each process chamber includes about 3-6 external sensors attached to the process chamber, sub-systems associated with the process chamber, and/or inputs/outputs to and from the process chamber. The second sensor data output by the external sensors 140, 142, 144, 152 may include, for example, current, flow, temperature, eddy current, concentration, vibration, voltage, or power factor. Examples of external sensors 140, 142, 144, 152 that may be used include clamp sensors that measure AC current or DC current (also referred to as a current clamp), clamp sensors that measure voltage, and clamp sensors that measure leakage current. Other examples of external sensors are vibration sensors, temperature sensors, ultrasonic sensors (e.g., ultrasonic flow sensors), accelerometers (i.e., acceleration sensors), etc.

In the example shown, an abatement system 130, a gas delivery system 134, a water system 132 and/or a CDA system 136 may provide environmental resources to the processing chambers 114, 116, 118 and/or to other components of the processing system 100 (e.g., to the transfer chamber, factory interface, load locks, etc.). In embodiments, the abatement system 130 performs abatement for residual gases, reactants and/or outputs associated with a process executed on a processing chamber 114, 116, 118. The abatement system 130 may burn residual gases and/or reactants, for example, to ensure that they do not pose an environmental risk. Additionally, in embodiments one or more pumps may be attached to and/or operate on behalf of one or more of the processing chambers 114, 116, 118. External sensors 140, 142, 144, 152 are shown with relation to a single processing chamber 116 as a simplification for the sake of clarity. However, it should be understood that similar external sensors may be attached on additional process chambers and/or on lines to and/or from such additional process chambers and/or to sub-systems associated with such additional process chambers.

The external sensors 140, 142, 144, 152 may be IoT sensors in some embodiments. In some embodiments, the external sensors include a power source such as a battery. In some embodiments, the external sensors are wired sensors that are plugged into a power source such as an AC power outlet. In some embodiments, the external sensors do not include a power source, and instead receive sufficient power to operate based on environmental conditions. For example, a sensor that detects voltage, power and/or current may be wirelessly powered by such power or current (e.g., by harvesting energy from current that runs through a wire that a sensor is clamped over).

In one embodiment, the external sensors 140, 142, 144, 152 are sensors having embedded systems. An embedded system is a class of computing device that is embedded into another device as one component of the device. The external sensors 140, 142, 144, 152 typically also include other hardware, electrical and/or mechanical components that may interface with the embedded system. Embedded systems are typically configured to handle a particular task or set of tasks, for which the embedded systems may be optimized (e.g., generating and/or sending measurements). Accordingly, the embedded systems may have a minimal cost and size as compared to general computing devices.

The embedded systems may each include a communication module (not shown) that enables the embedded system (and thus the external sensor 140, 142, 144, 152) to connect to a LAN, to a hub 150, and/or or to a wireless carrier network (e.g., that is implemented using various data processing equipment, communication towers, etc.). The communication module may be configured to manage security, manage sessions, manage access control, manage communications with external devices, and so forth.

In one embodiment, the communication module of the external sensors 140, 142, 144, 152 is configured to communicate using Wi-Fi®. Alternatively, the communication module may be configured to communicate using Bluetooth®, Zigbee®, Internet Protocol version 6 over Low power Wireless Area Networks (6LowPAN), power line communication (PLC), Ethernet (e.g., 10 Megabyte (Mb), 100 Mb and/or 1 Gigabyte (Gb) Ethernet) or other communication protocols. If the communication module is configured to communicate with a wireless carrier network, then the communication module may communicate using Global Systems for Mobile Communications (GSM), Code-Division Multiple Access (CDMA), Universal Mobile Telecommunications Systems (UMTS), 3GPP Long Term Evaluation (LTE), Worldwide Interoperability for Microwave Access (WiMAX), or any other second generation wireless telephone technology (2G), third generation wireless telephone technology (3G), fourth generation wireless telephone technology (4G) or other wireless telephone technology.

In one embodiment, the communication module is configured to communicate with hub 150, which may be, for example, a Wi-Fi router or other type of router, switch or hub. The hub 150 may be configured to communicate with the communication module of each of the external sensors 140, 142, 144, 152, and to send measurements received from the external sensors 140, 142, 144, 152 to system controller 128. In one embodiment, hub 150 has a wired connection (e.g., an Ethernet connection, a parallel connection, a serial connection, Modbus connection, etc.) to the system controller 128, and sends the measurements to the system controller 128 over the wired connection. In one embodiment, the hub 150 is connected to one or more external sensors via a wired connection.

In some embodiments, hub 150 is connected to a network device that is connected to a local area network (LAN). The system controller 128 and the network device may each be connected to the LAN via a wireless connection, and through the LAN may be wirelessly connected to one another. External sensors 140, 142, 144, 152 may not support any of the communication types supported by the network device. For example, external sensor 140 may support Zigbee, and external sensor 142 may support Bluetooth. To enable such devices to connect to the LAN, the hub 150 may act as a gateway device connected to the network device (not shown) via one of the connection types supported by the network device (e.g., via Ethernet or Wi-Fi). The gateway device may additionally support other communication protocols such as Zigbee, PLC and/or Bluetooth, and may translate between supported communication protocols.

The system controller 128 may be connected to a wide area network (WAN). The WAN may be a private WAN (e.g., an intranet) or a public WAN such as the Internet, or may include a combination of a private and public network. In embodiments, the system controller 128 may be connected to a LAN that may include a router and/or modem (e.g., a cable modem, a direct serial link (DSL) modem, a Worldwide Interoperability for Microwave Access (WiMAX®) modem, an long term evolution (LTE®) modem, etc.) that provides a connection to the WAN.

The WAN may include or connect to one or more server computing devices (not shown). The server computing devices may include physical machines and/or virtual machines hosted by physical machines. The physical machines may be rackmount servers, desktop computers, or other computing devices. In one embodiment, the server computing devices include virtual machines managed and provided by a cloud provider system. Each virtual machine offered by a cloud service provider may be hosted on a physical machine configured as part of a cloud. Such physical machines are often located in a data center. The cloud provider system and cloud may be provided as an infrastructure as a service (IaaS) layer. One example of such a cloud is Amazon's® Elastic Compute Cloud (EC2®).

The server computing device may host one or more services, which may be a web based service and/or a cloud service (e.g., a web based service hosted in a cloud computing platform). The service may maintain a session (e.g., via a continuous or intermittent connection) with the system controller 128 and/or system controllers of other manufacturing systems at a same location (e.g., in a fabrication facility or fab) and/or at different locations. Alternatively, the service may periodically establish sessions with the system controllers. Via a session with a system controller 128, the service may receive status updates from the eco-efficiency module 129 running on the system controller 128. The service may aggregate the data, and may provide a graphical user interface (GUI) that is accessible via any device (e.g., a mobile phone, tablet computer, laptop computer, desktop computer, etc.) connected to the WAN.

Eco-efficiency module 129 that executes on system controller 128 may process the first sensor data from the integral sensors of one or more process chambers 114, 116, 118 and second sensor data from external sensors 140, 142, 144, 152 to determine environmental resource usage data that reflects amounts of environmental resource consumption, such as water consumption, consumption of gases, electricity consumption, and so on. Operations that may be performed by the eco-efficiency module 129 are described below with reference to the remaining figures.

In some embodiments, the eco-efficiency module can predict the eco-efficiency of a process recipe run in one of processing chambers 114, 116, 118. In some examples, utilizing one or more machine learning models, the eco-efficiency module 129 can predict the environmental resource consumption of a process operation. Using multiple process recipes as input, the eco-efficiency module 129 can determine the environmental resource consumption for each of the recipes. In some embodiments, the system controller can output a recommendation for substrate processing after comparing the environmental resource consumption associated with performing each of the recipes. The recommendation may be for the most eco-efficient recipe to be performed. In some embodiments, the recommendation may include a modification to one of the process recipes to make the process recipe more eco-efficient. In some examples, the eco-efficiency module 129 can update the process recipe based on the modification included in the recommendation.

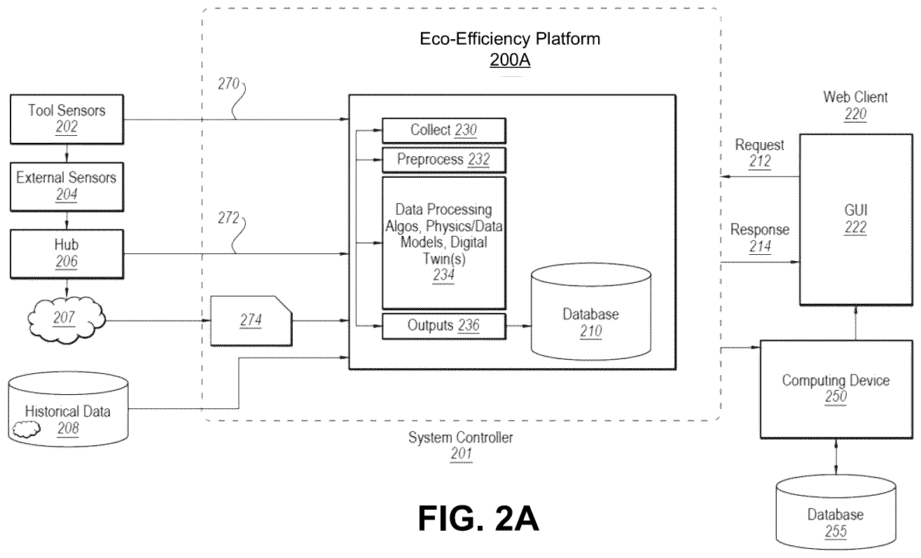

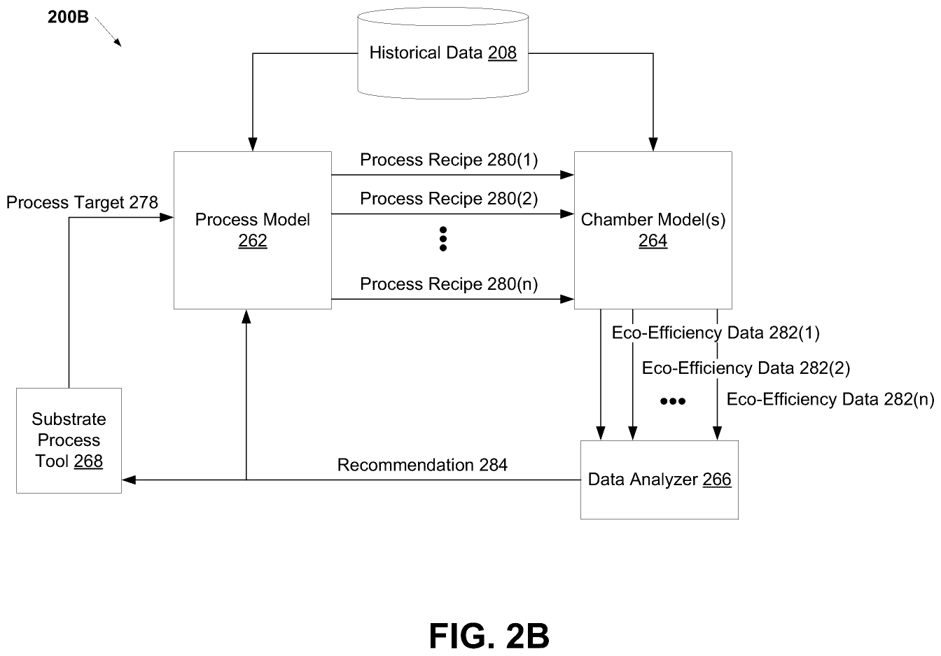

FIG. 2A is a block diagram illustrating a logical view of an exemplary eco-efficiency platform 200A, according to one embodiment. The eco-efficiency platform 200A may execute on a system controller 201 in embodiments. In one embodiment, system controller 201 corresponds to system controller 128 of FIG. 1, and eco-efficiency platform 200A is provided by eco-efficiency module 129 of FIG. 1.

The eco-efficiency platform 200 may receive first sensor data 270 from tool sensors 202, which may be integral sensors of process chambers 114, 116, 118 of FIG. 1 in some embodiments. Eco-efficiency platform 200 may additionally receive second sensor data 272 from a hub 206, where the hub 206 receives the second sensor data from one or more external sensors 204. The external sensors 204 may correspond to external sensors 140, 142, 144, 152 of FIG. 1 in some embodiments. In some embodiments, hub 206 provides the second sensor data to a server 207, which may execute on one or more computing device (e.g., in a cloud environment). The server 207 (e.g., an IoT platform) may aggregate the second sensor data into aggregated second sensor data 274, and may send the aggregated second sensor data 274 to eco-efficiency platform 200. Such aggregated second sensor data 274 may be provided to the eco-efficiency platform 200 instead of or in addition to second sensor data 272.

In some embodiments, historical data 208 (e.g., historical sensor data) may be stored in a data store such as a database. Such historical data 208 may additionally be provided to eco-efficiency platform 200 in some embodiments. In some embodiments, the historical data 208 can be used to train one or more machine learning models to predict eco-efficiency data as described herein.

At block 230, the eco-efficiency platform 200 collects the first sensor data 270, second sensor data 272, aggregated second sensor data 274 and/or historical data 208. At block 232, the eco-efficiency platform 200 may preprocess some or all of the received data. The preprocessing may include normalizing data, changing units of data, adding timestamps to data, synchronizing data based on time stamps, adding labels to data, and so on.

At block 234, the eco-efficiency platform 200 performs data processing on the received data (e.g., first sensor data 270 and second sensor data 272). This may include inputting the data into one or more data processing algorithms or functions, inputting the data into one or more physics-based models (e.g., such as digital twins), inputting the data into one or more trained machine learning models, and so on. At block 236, outputs are generated by the one or more models, data processing algorithms, functions, etc. The outputs may include physical conditions associated with a fabrication process executed on a process chamber and/or environmental resource usage data. The outputs may be stored in a local data store such as a database 210.

A client computing device executing a web client 220 or other client application that includes a graphical user interface (GUI) 222 or other type of user interface may interface with the eco-efficiency platform 200. The web client 220 may send requests 212 to the eco-efficiency platform 200 and receive responses 214. The requests 212 may include, for example, requests for environmental resource usage data for one or more process chambers, for a manufacturing system that includes multiple process chambers, for recipes that execute on the process chambers, and so on. The requests may include requests to present the environmental resource usage data in charts, tables, and so on.

In some embodiments, eco-efficiency platforms 200 of multiple system controllers 201 interface with a remote computing device 250 (e.g., via a WAN). The remote computing device 250 may include a remote server that aggregates data from multiple eco-efficiency platforms and stores the aggregated data in a data store such as database 255. The web client 220 (or other client application) may interface with the remote server of computing device 250 to access environmental resource usage data for multiple manufacturing systems in a fab, for multiple fabs, and so on.

FIG. 2B is a simplified block diagram illustrating a logical view of an exemplary eco-efficiency prediction platform in accordance with some implementations of the present disclosure. The eco-efficiency prediction platform 200B may execute on a system controller (e.g., system controller 201) in some embodiments. Alternatively, eco-efficiency prediction platform 200B may execute on a server computer, which may or may not execute in a cloud environment. In one embodiment, eco-efficiency prediction platform 200B is provided by eco-efficiency module 129 of FIG. 1.

The eco-efficiency prediction platform 200B may receive one or more process target 278 (e.g., a set of process targets) from a substrate process tool 268 or other source. In one embodiment, a user (e.g., a technician) inputs the one or more process targets via a user interface (e.g., graphical user interface) of eco-efficiency prediction platform 200B. In some embodiments, the one or more process target 278 includes target substrate process data indicative of a target substrate condition of a processed substrate. For example, the process target 278 may indicate a target processed substrate result and/or target substrate specification. In some examples, the process target 278 may indicate that a processed substrate is to have one or more features (e.g., etch features, deposition features, coating features, film thickness, etc.). The process target may be received by the substrate process tool 268 via user input (e.g., via a GUI).

In some embodiments, the process target 278 is input into a process model 262. The process model 262 may be a model such as a physics-based model, a statistical model, a trained machine learning model (e.g., one or more trained machine learning models), or a hybrid model (e.g., a combination of one or more model types). For example, the process model 262 may be a physics-informed trained machine learning model. In some embodiments, the process model 262 is trained to output multiple process recipes (e.g., process recipes 280(1)-280(n)) based on an input process target. In some embodiments, the process model 262 is representative of a substrate fabrication process. The process model 262 may be trained with historical data 208 including historical process targets, historical process recipes, and/or historical eco-efficiency data. The process model 262 may be trained with training input data including historical target substrate process data corresponding to process targets for varying substrate process operations. The historical target substrate process data may be collected over time as substrates are processed and/or as new process targets are received. The process model 262 may be trained with training target data including historical process recipes (e.g., historical process recipe setpoint data) corresponding to the historical target substrate process data. For example, the process model 262 may be trained with process recipe data (e.g., the training target output) and corresponding process target data (e.g., the training input) that the process recipes were to achieve. The historical process recipes may be collected over time during and/or prior to performance of new substrate process operations.

Output from the process model 262 are multiple process recipes 280(1)-280(n). In some examples, the process model 262 outputs n process recipes. Each process recipe 280 may indicate setpoints (e.g., process recipe setpoints, control knob setpoints, etc.) for one or more process recipe operations. In some embodiments, each of process recipes 280(1)-280(n) when performed produce a processed substrate that meets the process target 278 (e.g., meets a target specification, etc.). Each of the process recipes 280(1)-280(n) may have different process setpoints, such as different temperatures, gas flow rates, gas delivery times, pressures, and so on. Additionally, each of the process recipes 280(1)-280(n) may use differing amounts of environmental resources such as process gas and/or power. Accordingly, each of process recipes 280(1)-280(n) may have different eco-efficiencies.

In some embodiments, the process recipes 280(1)-280(n) are input into one or more chamber models 264. The chamber model(s) 264 may receive and/or make eco-efficiency predictions based on process recipes 280(1)-280(n) serially or in parallel. In some embodiments, multiple chamber models 264 are used, where some chamber models receive process recipes as well as outputs of other chamber models, and produce an output based on such input. In some embodiments, multiple chamber models are “daisy chained,” where a first model or models in the chain may output predictions for readings and/or resource consumption that has a direct and easy to understand correlation to sensor readings and/or recipe settings of a process recipe. Subsequent models may have a less easy or direct correspondence to recipe settings and/or sensor readings. However, there may be a correspondence between first readings/resource consumption output by a first model and readings/resource consumption output by a subsequent second model. The chamber model(s) 264 may each be a model such as a physics-based model, a statistical model, a trained machine learning model (e.g., one or more trained machine learning models), or a hybrid model (e.g., a combination of one or more model types). For example, the chamber model(s) 264 may be a physics-informed trained machine learning model.

The chamber model(s) 264 may be a model representative of a process chamber. For example, the chamber model(s) 264 may be a digital twin of a process chamber. In some embodiments, the chamber model(s) 264 is trained to output predicted environmental data (e.g., eco-efficiency data 282(1)-282(n)) corresponding to input process recipes. The chamber model 264 may be trained with historical data 208. The chamber model(s) 264 may be trained with training input data including historical process recipe data collected over time. For example, the chamber model(s) 264 may be trained with process recipe data corresponding to process recipe operations performed in a corresponding process chamber. In some embodiments, the chamber model(s) 264 includes two or more trained machine learning models. In some examples, a first machine learning model is trained using historical process recipe data and historical eco-efficiency data. The first machine learning model may be trained to output predicted measurements (e.g., predicted sensor measurements such as temperature, power, flow rate, and/or other data related to environmental resource consumption, etc.) based on an input process recipe. A second machine learning model may be trained with the output from the first machine learning model (e.g., predicted measurements), historical process recipes, and/or historical eco-efficiency data. The second machine learning model may be trained to output predicted eco-efficiency data based on input process recipe(s).

In some embodiments, the chamber model(s) 264 is trained with further training input data including sensor data (e.g., historical sensor data) associated with substrate processing received from sensors of a corresponding process chamber. In some embodiments, a second machine learning model of the chamber model(s) 264 is trained with predicted sensor data output by a first machine learning model of the chamber model(s) 264. The sensor data may include first sensor data and/or second sensor data as described herein. For example, the chamber model(s) 264 may be trained on data including measurements of current, voltage, power, flow (e.g., of one or more gases, CDA, water, etc.), pressure, concentration (e.g., of one or more gases), speed (e.g., of one or more moving parts, of gases, etc.), acceleration (e.g., of one or more moving parts, of gases, etc.), or temperature (e.g., of a substrate under process, of different locations in a processing chamber, and so on). In some embodiments, the sensor data is collected over time and stored in a database for later training of the chamber model(s) 264. In some embodiments, the sensor data is used to inform the chamber model(s) 264. For example, by providing the chamber model(s) 264 with historical sensor data, the chamber model(s) 264 may become a physics-informed trained machine learning model. Informing the chamber model(s) 264 may provide constraints for the chamber model(s) 264, therefore increasing the model accuracy.

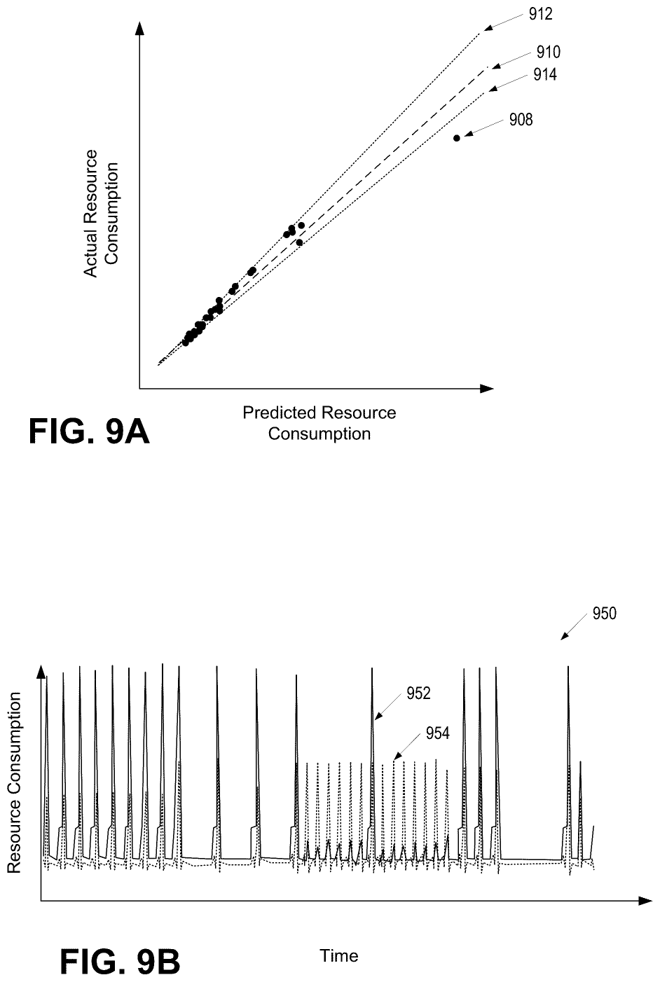

Predicted eco-efficiency data 282 is output from the chamber model(s) 264, in some embodiments. The eco-efficiency data 282 may indicate environmental resource usage (e.g., consumption) for the process recipes 280. In some examples, the eco-efficiency data 282 includes predicted time series data reflective of predicted behavior of a process chamber (e.g., energy use over time, gas consumption over time, etc.). FIG. 9B shows an example of predicted time series resource consumption data. In some examples, the eco-efficiency data 282 indicates time series data for predicted environmental resource consumption associated with substrate processing, such as predicted power consumption, predicted gas consumption, predicted water consumption, etc. over time. For each process recipe 280 input into the chamber model 264, a corresponding set of eco-efficiency data 282 is output. For example, based on process recipe 280(1) input into the chamber model 264, the chamber model 264 outputs eco-efficiency data 282(1). Similarly, based on process recipe 280(n) input into the chamber model 264, the chamber model 264 outputs eco-efficiency data 282(n). The chamber model 264 may output each set of eco-efficiency data 282(1)-282(n) serially or in parallel. In some embodiments, a data analyzer 266 receives the eco-efficiency data 282. The data analyzer 266 may perform data analytics operations on the eco-efficiency data 282. In some examples, the data analyzer 266 may perform comparisons of each set of eco-efficiency data 282 to determine the most eco-efficient corresponding process recipe 280.

In some embodiments, the data analyzer 266 outputs a recommendation 284 to the substrate process tool 268. The recommendation 284 may be associated with processing a substrate in a process chamber according to one of process recipes 280(1)-280(n). For example, based on (e.g., responsive to, etc.) eco-efficiency data 282(2) indicating that process recipe 280(2) is the most eco-efficient process recipe of process recipes 280(1)-280(n), the data analyzer 266 may recommend to the substrate process tool 268 that process recipe 280(2) should be implemented for processing substrates to meet the process target 278. In some embodiments, the recommendation 284 includes a modification to one of process recipes 280 and/or a modification to the process target 278 to increase the eco-efficiency of a process recipe. In some embodiments, the modification includes one or more additional targets, one or more constraints for process recipes (e.g., maximum temperatures, minimum temperatures, etc.) for process recipes. In an example, the data analyzer 266 may determine that to increase the eco-efficiency of one of process recipes 280, the previously predicted process recipe(s) should be changed. The data analyzer 266 may indicate the change to the substrate process tool 268 via recommendation 284. In some embodiments, the modification to the process recipe is to form a modified process recipe. The modified process recipe may have a reduced environmental resource consumption (e.g., a greater eco-efficiency) compared to the unmodified process recipe. In some embodiments, the data analyzer 266 utilizes one or more trained machine learning models trained to output the recommendation 284 based on the input eco-efficiency data 282.

In some embodiments, the recommendation 284 is received by the process model 262. The recommendation 284 may be used by the process model 262 to predict further process recipes 280(1)-280(n) that will have lower resource consumption and/or that meets one or more updated process targets and/or newly added constraints.

In some examples, the process model 262 is further trained with training input including historical recommendations 284. The process model 262 may utilize the recommendation 284 indicating a modification to a process recipe to output further predicted process recipes 280(1)-280(n) that are more eco-efficient than previously predicted process recipes. Thus, an iterative cycle may be established. For each cycle, the process target 278 can be updated based on the recommendation 284, the process model 262 can output updated process recipes based on the updated process target, the chamber model 264 can output updated eco-efficiency data based on the updated process recipes, the data analyzer 266 can output an updated recommendation based on the updated eco-efficiency data, etc. In some examples, the process model 262 can output more efficient process recipes 280 indicated by eco-efficiency data 282. The data analyzer 266 may then output a recommendation 284 for further modification of the determined most eco-efficient process recipe and/or a modification of the process target 278 to further increase the eco-efficiency of a process recipe or recipes. The substrate process tool 268 may cause substrate processing in a process chamber based on the process target 278 and/or the recommendation 284. For example, the substrate process tool 268 may initialize substrate processing using a process indicated by the recommendation 284 to meet the process target 278.

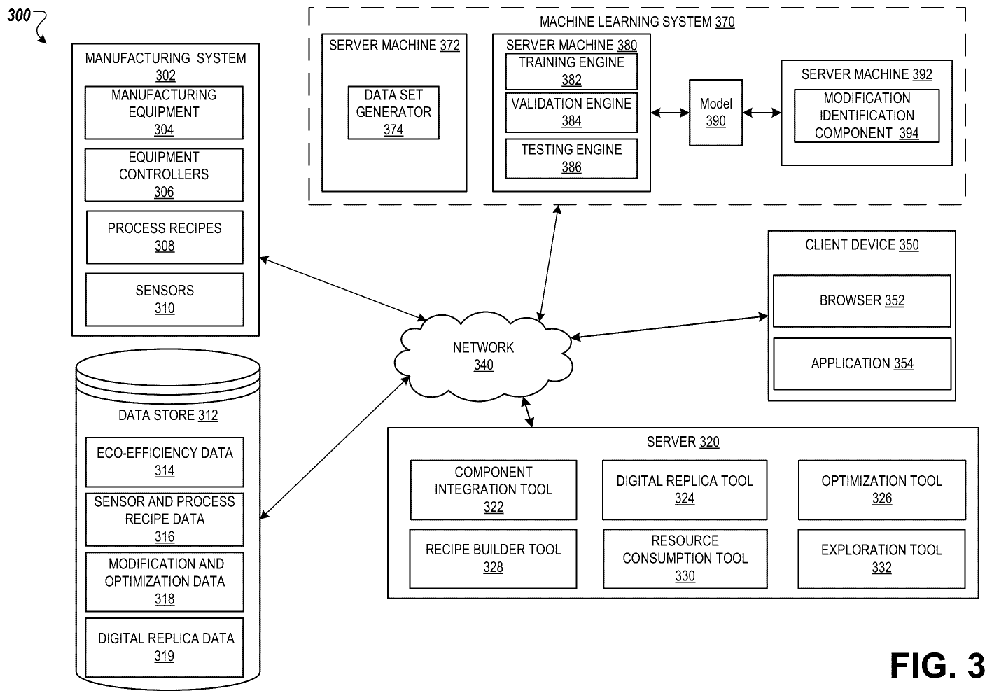

FIG. 3 is a block diagram illustrating an exemplary system architecture 300 in which implementations of the disclosure may operate. As shown in FIG. 3, system architecture 300 includes a manufacturing system 302, a data store 312, a server 320, a client device 350, and/or a machine learning system 370. The machine learning system 370 may be a part of the server 320. In some embodiments, one or more components of the machine learning system 370 may be fully or partially integrated into client device 350. The manufacturing system 302, the data store 312, the server 320, the client device 350, and the machine learning system 370 can each be hosted by one or more computing devices including server computers, desktop computers, laptop computers, tablet computers, notebook computers, personal digital assistants (PDAs), mobile communication devices, cell phones, hand-held computers, augmented reality (AR) displays and/or headsets, virtual reality (VR) displays and/or headsets, mixed reality (MR) displays and/or headsets, or similar computing devices. The server, as used herein, may refer to a server but may also include an edge computing device, an on premise server, a cloud, and the like.

The manufacturing system 302, the data store 312, the server 320, the client device 350, and the machine learning system 370 may be coupled to each other via a network (e.g., for performing methodology described herein). In some embodiments, network 360 is a private network that provides each element of system architecture 300 with access to each other and other privately available computing devices. Network 360 may include one or more wide area networks (WANs), local area networks (LANs), wires network (e.g., Ethernet network), wireless networks (e.g., an 802.11 network or a Wi-Fi network), cellular network (e.g., a Long Term Evolution (LTE) network), cloud network, cloud service, routers, hubs, switches server computers, and/or any combination thereof. Alternatively or additionally, any of the elements of the system architecture 300 can be integrated together or otherwise coupled without the use of the network 360.

The client device 350 may be or include any personal computers (PCs), laptops, mobile phones, tablet computers, netbook computers, network connected televisions (“smart TV”), network-connected media players (e.g., Blue-ray player), a set-top-box, over-the-top (OOT) streaming devices, operator boxes, etc. The client device 350 may include a browser 352, an application 354, and/or other tools as described and performed by other systems of the system architecture 300. In some embodiments, the client device 350 may be capable of accessing the manufacturing system 302, the data store 312, the server 320, and/or the machine learning system 370 and communicating (e.g., transmitting and/or receiving) indications of predicted eco-efficiency including one or more predicted environmental resource consumption (e.g., an environmental resource consumption) and/or predicted environmental impact, and/or inputs and outputs of various process tools (e.g., component integration tool 322, digital replica tool 324, optimization tool 326, recipe builder tool 328, resource consumption tool 330, and so on) at various stages of processing of the system architecture 300, as described herein.

As shown in FIG. 3, manufacturing system 302 includes machine equipment 304, system controllers 306, process recipes 308, and sensors 310. The machine equipment 304 may be any combination of an ion implanter, an etch reactor (e.g., a processing chamber), a photolithography devices, a deposition device (e.g., for performing chemical vapor deposition (CVD), physical vapor deposition (PVD), ion-assisted deposition (IAD), and so on), or any other combination of manufacturing devices.

Process recipes 308, also referred to as fabrication recipes or fabrication process instructions, include an ordering of machine operations with process implementation that when applied in a designated order create a fabricated sample (e.g., a substrate having predetermined target properties or meeting predetermined target specifications). In some embodiments, the process recipes are stored in a data store or, alternatively or additionally, stored in a manner to generate a table of data indicative of the operations of the fabrication process. Each operation may be associated with known environmental resource usage data. Alternatively or additionally, each process operation may be associated with parameters indicative of physical conditions of a process operation (e.g., target pressure, temperature, exhaust, energy throughput, and the like).

System controllers 306 may include software and/or hardware components capable of carrying out operations of process recipes 308. The system controllers 306 may monitor a manufacturing process through sensors 310. Sensors 310 may measure process parameters to determine whether process criteria (e.g., target process criteria) are met. Process criteria may be associated with a process parameter value window. Sensors 310 may include a variety of sensors that can be used to measure (explicitly or as a measure of) consumptions (e.g., power, current, etc.) associated with substrate processing. Sensors 310 could include physical sensors, integral sensors that are components of process chambers, external sensors, Internet-of-Things (IoT) and/or virtual sensors (e.g., Sensors that are not physical sensors but based virtual measurements based on model that estimate parameter values), and so on.

Additionally or alternatively, system controllers 306 may monitor the eco-efficiency by measuring resource consumption of various process operations (e.g., exhaust, energy consumption, process ingredient consumption etc.). In some embodiments, the system controllers 306 determine the eco-efficiency of associated machine equipment 304. System controllers 306 may also adjust settings associated with the manufacturing equipment 304 based on the predicted and/or determined eco-efficiency models (e.g., including determined and/or predicted modifications to process recipes 308) so as to optimize the eco-efficiency of equipment 304 in light of the current manufacturing conditions.

In one embodiment, system controllers 306 may include a main memory (e.g., read-only memory (ROM), flash memory, dynamic random access memory (DRAM), static random access memory (SRAM), etc.), and/or secondary memory (e.g., a data store device such as a disk drive (e.g., data store 312 or cloud data). The main memory and/or secondary memory may store instructions for performing various types of manufacturing processes (e.g., process recipes 308).

In one embodiment, system controllers 306 may determine an actual eco-efficiency characterization associated with the manufacturing equipment 304 based on first utility use data associated with the manufacturing equipment 304 and first utilization data associated with the manufacturing equipment 304. The first utility use data and first utilization data may be determined by the system controllers 306, for example. In another embodiment, the first utility use data and first utilization data are received from an external source (e.g., server 320, cloud service and/or cloud data store). System controllers 306 may compare the actual eco-efficiency characterization to a first eco-efficiency characterization (e.g., a first estimated eco-efficiency characterization) and/or a predicted eco-efficiency associated with the manufacturing equipment 304. The eco-efficiency characterizations may be different when different use and utilization data values were used to compute the first eco-efficiency characterization than the actual values associated with the operating manufacturing equipment 304.

In one embodiment, system controllers 306 may determine that the predicted eco-efficiency characterization is more eco-efficient than the actual eco-efficiency characterization, indicating that it may be possible to adjust settings on the manufacturing equipment 304 to better optimize the manufacturing equipment 304 for eco-efficiency. In some embodiments, manufacturing equipment 304 may control and/or adjust subcomponent settings to better optimize eco-efficiency.

System controllers 306 may also determine that actual use data or actual utilization data is not the same as predicted use data and utilization data that are associated with the first eco-efficiency characterization. This may be the case when nominal or estimated data values are used to determine the first eco-efficiency characterization and different, actual recorded data values are used while the manufacturing equipment 304 is in operation. In such a scenario, an adjustment to one or more settings associated with the manufacturing equipment 304 may be beneficial to optimize the eco-efficiency of the manufacturing equipment.

Data store 312 may be a memory (e.g., a random access memory), a drive (e.g., a hard drive, a flash drive), a database system, or another type of component or device capable of storing data such as a store provided by a cloud server and/or processor. Data store 312 may store one or more historical sensor data. Data store 312 may store one or more eco-efficiency data 314 (e.g., including historical, predicted, and/or current eco-efficiency data), sensor and process recipe data 316 (e.g., including historical, predicted and/or current sensor and process recipe data 316), modification and optimization data (e.g., including historical, predicted, and/or current modification and optimization data 318), and digital replica data 319. The sensor and process recipe data 316 may include various process operations, process parameter windows, alternative process operations, process queuing instruction, and so on for performing multiple processes on overlapping manufacturing equipment. The sensor and process recipe data 316 may be linked or otherwise associated with the eco-efficiency data 314 to track and/or predict eco-efficiency across various process operations, recipes, etc. The modification and optimization data 318 may include historical modifications made to prior process recipes (including individual process operations, or coordination of multiple process recipes) and associated eco-efficiency changes resulting from the modifications.

The eco-efficiency data 314 may include various consumption resources used in an eco-efficiency characterization and/or prediction. In one embodiment, eco-efficiency data 314 incorporates one or more of water usage, emissions, electrical energy usage, and any combination thereof associated with substrate processing. In some embodiments, eco-efficiency data 314 may include resource consumption for other categories, such as gas usage, heavy metals usage, and eutrophication potential.

The digital replica data 319 may include data associated with a digital replica. The digital replica data 319 may include data associated with a digital twin. As used herein, a digital twin may include a digital replica of a physical asset, such as manufacturing equipment 304. The digital twin includes characteristics of the physical asset at each stage of the manufacturing process, in which the characteristics include, but are not limited to, coordinate axis dimensions, weight characteristics, material characteristics (e.g., density, surface roughness), electrical characteristics (e.g., conductivity), optical characteristics (e.g., reflectivity), etc.

As previously discussed, a digital replica may include a physics-based model of one or more physical assets of the substrate fabrication system. The digital replica data 319 may encapsulate relationships, parameters, specifications, etc. associated with one or more aspects of the physics-based model. For example, the physics-based model may indicate a relationship between a size and a geometry of a substrate process chamber and the environment resource consumption. The physics-based model may indicate a relationship between a type of purge gas used within the substrate fabrication system and the environment resource consumption.

Server 320 may include a component integration tool 322, a digital replica tool 324, an optimization tool 326, a recipe builder tool 328, a resource consumption tool 330, and/or an exploration tool. The component integration tool 322 may determine a cumulative consumption per device (e.g., per individual manufacturing equipment). The various tools of server 320 may communicate data between each other to carry out each respective function, as described herein.

The component integration tool 322 may receive manufacturing data (e.g., recipes, selections of recipes, manufacturing equipment, inter-recipe and intra-recipe processes, and so on) and perform an eco-efficiency prediction analysis across varying divisions of the data. In some embodiments, the component integration tool 322 may determine an eco-efficiency characterization across multiple process operations from an individual process recipe. For example, the component integration tool 322 may determine an eco-efficiency prediction across all operations of a substrate fabrication process from start to finish. For example, each fabrication operation may include one or more fabrication operations (e.g., hundreds of fabrication operations) each having an eco-efficiency prediction and together a collective eco-efficiency prediction. In another example, a selection of the processes may be used to predict an eco-efficiency of a subset of the fabrication process operations.

In another embodiment, the component integration tool 322 may perform an eco-efficiency prediction of inter recipe processes. For example, an eco-efficiency prediction may be associated with a manufacturing device (e.g. of manufacturing system 302) performing multiple different process operations from multiple different manufacturing processes (e.g. process recipes 308). In another example, the ordering of various process operations (e.g., intra-recipe or inter-recipe) may affect an overall eco-efficiency. The component integration tool 322 may perform an overall eco-efficiency prediction across a system of manufacturing devices and/or sequence of processes. For example, the component integration tool 322 may perform an eco-efficiency comparison between subcomponents performing similar functions (e.g., multiple processing chambers).

In an illustrative example, each process operation may be done by a processing chamber such as epitaxial deposition or etch. Each of these is done using a process recipe. There may be many different process recipes for performing a process such as epitaxial deposition. For example, a process recipe may include multiple operations such as: 1) purge the chamber; 2) pump; 3) flow in gases; 4) heat the chamber, and so on. These operations may be associated with one or more process recipes.

In another embodiment, the component integration tool 322 may perform an eco-efficiency prediction that includes eco-efficiency of auxiliary equipment. Auxiliary equipment may include equipment not directly used for manufacturing but that assists in carrying out various process recipes. For example, auxiliary equipment may include substrate transport systems designed to move wafers between various fabrication devices. In another example, auxiliary equipment may include heat sinks, shared exhaust ports, power delivery system, etc. The component integration tool 322 may account for auxiliary device resource consumption and combine auxiliary device resource consumption with fabrication resource consumption to predict a resource consumption for a process recipe (e.g., subset or whole recipe) or combination of recipes (e.g., subsets or whole recipes).

In another embodiment, the component integration tool 322 may perform an eco-efficiency prediction that accounts for a sequence of processes or recipes. For example, performing process operation A followed by process operation B may result in a first resource consumption while performing process operation B followed by process operation A may result in a second resource consumption different than the first resource consumption. The component integration tool 322 integrates an eco-efficiency over multiple machine equipment and/or process operations and accounts for the sequence of process operations for a process recipe (e.g., subset or whole recipe) or combination of recipes (e.g., subset or whole recipes).

In some embodiments, there is different manufacturing equipment for each of the process operations. For example a film on a wafer may have multiple layers. A first machine may perform a first operation (e.g., deposition), a second machine may perform a second operation (e.g., etching), a third machine may perform a third operation (e.g., deposition), and so on. The component integration tool 322 may instruct a resource consumption tracker to track multiple processing operations across multiple machines to generate a data stash report. As mentioned previously, a consumption report can be drawn for a selection of a processing recipe, including the life of a wafer from start to finish.

In some embodiments, the component integration tool 322 may perform a chamber to chamber environmental resource consumption comparison. The component integration tool may leverage the digital replica tool 324 to provide one or more physics data that indicates rationale for the difference in eco-efficiency between the two chambers.

The digital replica tool 324 receives manufacturing data from manufacturing system 302 and/or client device 350 and generates a digital replica associated with the manufacturing data. The manufacturing data my include a selection of machine equipment 304 and process operations to a process recipe 308. The digital replica tool 324 generates a digital twin of the physical system architecture of the manufacturing system or a virtual inputted system (e.g., generated by a user on the client device 350).

The digital replica generated by the digital replica tool 324 may include one of a physics model, a statistical model, and/or a hybrid model. A physics model may include physics based constraints and control algorithms designed to estimate physical conditions (e.g., exhaust temperatures, power delivery requirements, and/or other conditions indicative of a physics environment associated with environmental resource consumption) of the inputted manufacturing data. For example, a user may create a process recipe on client device 350. The process recipe may include parameters for a process or recipe and instructions to use machine equipment in a certain way. The digital replica tool 324 may take this manufacturing data and determine physical constraints of the system (e.g., operating temperature, pressure, exhaust parameters, etc.). For example, the physics model may identify physical conditions of a system based on the hardware configurations of chamber (e.g., using equipment material of type A versus equipment material of type B) and/or recipe parameters. In another example, physical conditions may be determined from relevant machine equipment parts that affect heat loss to water, air, and/or heating ventilation, and air conditioning (HVAC) equipment. The digital replica tool 324 may work with other tools (e.g., component integration tool 322 and/or resource consumption tool 330) to formulate an eco-efficiency prediction associated with the received manufacturing data. It should be noted that the digital replica tool 324 may predict an eco-efficiency of a manufacturing process and selection of manufacturing equipment without receiving empirical data from performing the process recipe by the manufacturing equipment 304. Accordingly, digital replicas of manufacturing equipment may be used to predict the eco-efficiency of equipment designs and/or process recipes without actually building particular equipment designs or running particular process recipes.

In some embodiments, the digital replica tool 324 may operate in association with a digital twin. As used herein, a digital twin is a digital replica of a physical asset, such as a manufactured part. The digital twin includes characteristics of the physics asset at each stage of the manufacturing process, in which the characteristics include, but are not limited to, coordinate axis dimensions, weight characteristics, material characteristics (e.g., density, surface roughness), electrical characteristics (e.g., conductivity), optical characteristics (e.g., reflectivity), among other things.

In some embodiments, the physical models used by the digital replica tool 324 may include fluid flow modeling, gas flow and/or consumption modeling, chemical based modeling, heat transfer modeling, electrical energy consumption modeling, plasma modeling, and so on.

In some embodiments, the digital replica tool 324 may employ statistical modeling to predict eco-efficiency of manufacturing data. A statistical model may be used to process manufacturing data based on previously processed historical eco-efficiency data (e.g., eco-efficiency data 314) using statistical operations to validate, predict, and/or transform the manufacturing data. In some embodiments, the statistical model is generated using statistical process control (SPC) analysis to determine control limits for data and identify data as being more or less dependable based on those control limits. In some embodiments, the statistical model is associated with univariate and/or multivariate data analysis. For example, various parameters can be analyzed using the statistical model to determine patterns and correlations through statistical processes (e.g., range, minimum, maximum, quartiles, variance, standard deviation, and so on). In another example, relationships between multiple variables can be ascertained using regression analysis, path analysis, factor analysis, multivariate statistical process control (MCSPC) and/or multivariate analysis of variance (MANOVA).

The optimization tool 326 may receive selection of process recipes 308 and machine equipment 304 and identify modifications to the selections to improve eco-efficiency (e.g., reduce resource consumption, resource cost consumption, and/or environmental impact (e.g., gaseous or particulate species entering the atmosphere)). The optimization tool 326 may incorporate use of one or more machine learning models (e.g., model 390 of machine learning system 370). In some examples, a first machine learning model may receive as input a target substrate output associated with target results for a processed substrate. A second machine learning model may receive as input (e.g., output from the first machine learning model) a selection of process recipes and determine eco-efficiency data corresponding to each recipe of the selection of process recipes. In some embodiments, the machine learning model can determine one or more modification to the selection that improves overall eco-efficiency of the selection when performed by the manufacturing system 302. In some embodiments, the machine learning model may use the digital replica tool for generating synthetic manufacturing data for training. Alternatively or additionally, the machine learning model may use historical data (e.g., eco-efficiency data 314, sensor and process recipe data 316, and/or modification and optimization data 318) to train the machine learning model.

The modifications identified by the optimization tool 326 may include altering a process operation, changing the order of a process, altering parameters performed by a piece of machine equipment, altering an interaction of a first process recipe with a second process recipe (e.g., order, simultaneous operations, delay times, etc.), and so on. In some embodiments, the optimization tool 326 may send instruction to manufacturing system 302 to perform the optimization directly. However, in other embodiments, the optimization tool may display the modifications on a graphical user interface (GUI) for an operator to act upon. For example, the digital replica tool 324 may send one or more modification to the client device 350 for display in the browser 352 and/or application 354.

In some embodiments, the optimization tool 326 may adjust hyper parameters of a digital twin model generated by the digital replica tool 324. As will be discussed in later embodiments, the optimization tool 326 may incorporate reinforcement learning and/or deep learning by running simulated modifications on the digital replica and evaluating predicted eco-efficiency outcomes output from the digital replica.

In some embodiments, the optimization tool 326 may perform an eco-efficiency prediction and optimization that prioritizes one or more types of environmental resources. For example, as described previously eco-efficiency prediction can be based on various predicted resource consumptions such as water usage, gas usage, energy usage, and so on. The optimization tool 326 may perform an optimization that prioritizes a first resource consumption (e.g., water usage) over a second resource consumption (e.g., gas usage). In some embodiments, the optimization tool 326 may perform an optimization that uses a weighted priority system. For example, when optimizing eco-efficiency and/or identifying eco-efficiency modification to a fabrication process one or more resource consumptions may be assigned a weight indicative of an optimization priority for the associated per-unit resource consumption.

The recipe builder tool 328 may receive a selection of manufacturing processes and/or machine equipment and predict eco-efficiency dynamically step-by-step after each addition, deletion, and/or modification to a virtual manufacturing process and/or equipment selection. Recipe builder tool 328 can use other tools (e.g., component integration tool 322, the digital replica tool 324, optimization tool 326, and resource consumption tool 330) to dynamically update a determined eco-efficiency when a manufacturing recipe is updated. For example, a user may create a manufacturing recipe. The recipe builder tool 328 may output a current eco-efficiency of a current iteration of a process recipe. The recipe builder tool 328 may receive a modification to the current iteration that updated the process recipe. The recipe builder tool 328 may output an updated eco-efficiency prediction. In some embodiments, recipe builder tool 328 uses one or more models to predict substrate process recipes that meet a threshold criterion. (See FIG. 2B and associated description).

In some embodiments, the recipe builder tool 328 and the optimization tool 326 may be used to identify one or more recipes as being more eco-efficient than others. For example the recipe builder tool 328 may cause or other provide for presentation on GUI (e.g., client device 350) one or more (e.g., the top three) of the most energy-efficient recipes associated with a process tool. The recipe builder tool 328 may provide, using the digital replica tool 324, details that indicate rationale for why the one or more energy-efficient recipes are performing at the corresponding high eco-efficiency.

The resource consumption tool 330 may track various resource consumptions (e.g., predicted resource consumptions). For example, as mentioned previously eco-efficiency prediction may be based on more widespread resources such as energy consumption, gas emissions, water usage, etc. However, the resource consumption tool 330 can track predicted resource consumption more specifically. In some embodiments, a selection of process recipes and/or manufacturing equipment is received by resource consumption tool 330. The resource consumption tool 330 can determine life-cycle data of a component associated with the selection of manufacturing equipment and/or process recipes. For example, manufacturing equipment wears down over use and in some instances corrective action such as replacement and/or repairing a component is needed. This corrective action also is associated with a predicted environmental consumption (e.g., predicted resource consumption to perform the corrective action). The resource consumption tool 330 can individually track component life-time data and provide a per-unit environmental resource consumption and/or environmental impact based on anticipated future corrective action to be performed.

In some embodiments, the environmental resource consumption can be predicted, monitored, tracked, and/or otherwise determined across a variety of breakdowns. In some embodiments, the resource consumption tool 330 can predict resource consumption based on a selected process recipe. In some embodiments, the resource consumption tool 330 may perform live monitoring of energy, gas and water consumption. The resource consumption tool 330 may determine a chamber level consumption including calculating a total electrical, gas, and water consumption of a chamber (e.g., per wafer, per day, per week, per year, etc.). The resource consumption tool 330 may determine tool level consumption including determining a total electrical, gas, and water consumption of a tool (e.g., per day, per week, per year, etc.). The resource consumption tool 330 may determine individual gas consumption including determining a break up of individual gas consumption (e.g., per wafer, per day, per week, per year, etc.) The resource consumption tool 330 may generate a standard report including a chamber and tool level energy, gas, and water consumption.

In some embodiments, the resource consumption tool 330 may predict total electrical, gas, and water consumption of all the subfab components (e.g., per day, per week, per year, etc.) The resource consumption tool may determine recipe level consumption including total electrical, gas, and water consumption of any recipe run on a corresponding chamber and/or tool. The resource consumption tool may determine component level consumption including a break up of energy consumption for all energy consuming components in a chamber. The resource consumption tool 330 may perform an on demand customized report including determining on demand customized information and customized eco-efficiencies reports on demand. The resource consumption tool 330 may perform a comparison between energy consumption for different recipes and/points in time including quantifying energy savings, and energy savings opportunities using recipe optimization (e.g., using optimization tool 326).

The exploration tool 332 may communicate with digital replica tool 324 in determining the effects of one or more updates to manufacturing equipment 304. The exploration tool 332 may leverage the digital replica tool 324 to generate a digital replica that includes a digital reproduction of the substrate fabrication system (e.g., manufacturing equipment 304). The exploration tool may receive an update to the manufacturing equipment and allow a user to explore various alternative arrangement to equipment used, configuration of equipment, process parameters associated with equipment performance, among other things. The exploration tool 332 may employ the resource consumption tool 330 to determine environmental resource usage data corresponding to performing the one or more process procedures by the substrate fabrication system incorporating the update as described herein. The environmental resource usage data may be provided for display on a graphical user interface (GUI) (e.g., on client device 350).

In some embodiments, environmental resource usage data determined and/or predicted by other tools of the server may include predicted environmental resource consumption and/or predicted environmental impact associated with one of a replacement procedure or an upkeep procedure of a consumable part of the first manufacturing equipment. In some embodiments, the optimization tool 326 may determine modifications to a manufacturing process that may include performing a corrected action associated with a component of the machine equipment (e.g., machine equipment 304).

The exploration tool 332 may perform a cost of ownership analysis associated with the fabrication system. The cost of ownership analysis may include a comprehensive analysis into the interworking of a fabrication system to calculate a total cost to own and/or operate the system. The exploration tool 332 may calculate a cost for a customer to perform a particular fabrication procedure. The exploration tool 332 may determine a wafer cost, a cost corresponding to the gas used by the system, a cost associated with a tool being used (e.g., lifetime degradation data), and electricity for performing one or more process procedures by the fabrication system. The cost of ownership may be calculated on a per-unit (e.g., per wafer basis).

In some embodiments, machine learning system 370 further includes server machine 372, server machine 380, and/or server machine 392. Server machine 372 includes a data set generator 374 that is capable of generating data sets (e.g., a set of data inputs and a set of target outputs) to train, validate, and/or test a machine learning model 390.

Server machine 380 includes a training engine 382, a validation engine 384, and/or a testing engine 386. An engine (e.g., training engine 382, a validation engine 384, and/or a testing engine 386) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 382 may be capable of training a machine learning model 390 using one or more sets of features associated with the training set from data set generator 374. The training engine 382 may generate one or multiple trained machine learning models 390, where each trained machine learning model 390 may be trained based on a distinct set of features of the training set and/or a distinct set of labels of the training set. For example, a first trained machine learning model may have been trained using resource consumption data output by the digital replica tool 324, a second trained machine learning model may have been trained using historical eco-efficiency data (e.g., eco-efficiency data 314), and so on.

The validation engine 384 may be capable of validating a trained machine learning model 390 using the validation set from data set generator 374. The testing engine 386 may be capable of testing a trained machine learning model 390 using a testing set from data set generator 374.

The machine learning model(s) 390 may refer to the one or more trained machine learning models that are created by the training engine 382 using a training set that includes data inputs and, in some embodiments, corresponding target outputs (e.g., correct answers for respective training inputs). Patterns in the data sets can be found that cluster the data input and/or map the data input to the target output (the correct answer), and the machine learning model 390 is provided mappings and/or learns mappings that capture these patterns. The machine learning model(s) 390 may include artificial neural networks, deep neural networks, convolutional neural networks, recurrent neural networks (e.g., long short term memory (LSTM) networks, convLSTM networks, etc.), and/or other types of neural networks. The machine learning models 390 may additionally or alternatively include other types of machine learning models, such as those that use one or more of linear regression, Gaussian regression, random forests, support vector machines, and so on.

One type of machine learning model that may be used to perform some or all of the above asks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a machine learning model may roughly be divided into supervised learning and unsupervised learning. Both techniques for training a machine learning model may be used in embodiments. In one embodiment, training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

For model training, a training dataset containing hundreds, thousands, tens of thousands, hundreds of thousands or more data inputs should be used to form a training dataset. In embodiments, up to thousands, tens of thousands, hundreds of thousands or millions of cases of historical data (e.g., of processes executed in processing chambers and associated labels of resource consumption) may be available for forming a training dataset, where each case may include various labels of one or more types of useful information. Each case may include, for example, data showing a process chamber, a recipe, various resource utilizations, and so on. This data may be processed to generate one or multiple training datasets for training of one or more machine learning models. The machine learning models may be trained, for example, to predict process recipe(s), to estimate resource consummation and/or eco-efficiency, to propose modifications to a recipe and/or process chamber, and so on based on input process chamber, recipe, and/or process target information. Such trained machine learning models can be added to an eco-efficiency dashboard, and can be applied to provide detailed information about resource consumption and eco-efficiency as well as ways to reduce resource consumption and/or improve eco-efficiency before, during and/or after execution of a process on a process chamber.

Processing logic may gather a training dataset comprising historical process run information having one or more associated labels (e.g., of resource consumption, eco-efficiency values, recommendations for improved process recipe parameters, process recipe parameters, etc.). The training dataset may additionally or alternatively be augmented. Training of large-scale neural networks generally uses tens of thousands of inputs, which are not easy to acquire in many real-world applications. Data augmentation can be used to artificially increase the effective sample size.

To effectuate training, processing logic inputs the training dataset(s) into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the data inputs into the machine learning model one at a time. Each input may include data from a historical process run in a training data item from the training dataset. The machine learning model processes the input to generate an output. An artificial neural network includes an input layer that consists of values in a data point (e.g., intensity values and/or height values of pixels in a height map). The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce. Accordingly, the output may include predicted or estimated resource consumption for one or more types of resources, may include an eco-efficiency value, and so on.

Processing logic may then compare the generated output to the known label that was included in the training data item. Processing logic determines an error (i.e., a classification error) based on the differences between the output and the provided label(s). Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

Modification identification component 394 may provide current data to the trained machine learning model 390 and may run the trained machine learning model 390 on the input to obtain one or more outputs. The modification identification component 394 may be capable of making determinations and/or performing operations from the output of the trained machine learning model 390. ML model outputs may include confidence data that indicates a level of confidence that the ML model outputs (e.g., modification and optimization parameters) correspond to modifications that when applied improve an overall eco-efficiency of a selection of a manufacturing process and/or manufacturing equipment. The modification identification component 394 may perform process recipe modifications based on the ML model outputs in some embodiments. The modification identification component 394 may provide the ML model outputs to one or more tools of the server 320.

The confidence data may include or indicate a level of confidence that the ML model output is correct (e.g., ML model output corresponds to a known label associated with a training data item). In one example, the level of confidence is a real number between 0 and 1 inclusive, where 0 indicates no confidence that the ML model output is correct and 1 indicates absolute confidence that the ML model output is correct. Responsive to the confidence data indicating a level of confidence below a threshold level for a predetermined number of instances (e.g., percentage of instances, frequency of instances, total number of instances, etc.) the server 320 may cause the trained machine learning model 390 to be re-trained.

For purpose of illustration, rather than limitation, aspects of the disclosure describe the training of a machine learning model using process target data and/or process recipe data and inputting a current selection of a manufacturing process and/or manufacturing equipment into the trained machine learning model to determine machine learning model output (predicted eco-efficiency data based on the process target such as predicted resource consumption, etc.). In other implementations, a heuristic model or rule-based model is used to determine an output (e.g., without using a trained machine learning model).

In some embodiments, the functions of manufacturing system 302, client device 350, machine learning system 370, data store 312, and/or server 320 may be provided by a fewer number of machines. For example, in some embodiments server machines 372 and 380 may be integrated into a single machine, while in some other embodiments, server machine 372, server machine 380, and server machine 392 may be integrated into a single machine. In some embodiments, server 320, manufacturing system 302, and client device 350 may be integrated into a single machine.

In general, functions described in one embodiment as being performed by manufacturing system 302, client device 350, and/or machine learning system 370 can also be performed on server 320 in other embodiments, if appropriate. In addition, the functionality attributed to a particular component can be performed by different or multiple components operating together. For example, in some embodiments, the server 320 may receive manufacturing data and perform machine learning operations. In another example, client device 350 may perform the manufacturing data processing based on output from the trained machine learning model.

In addition, the functions of a particular component can be performed by different or multiple components operating together. One or more of the server 320, manufacturing system 302, or machine learning system 370 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

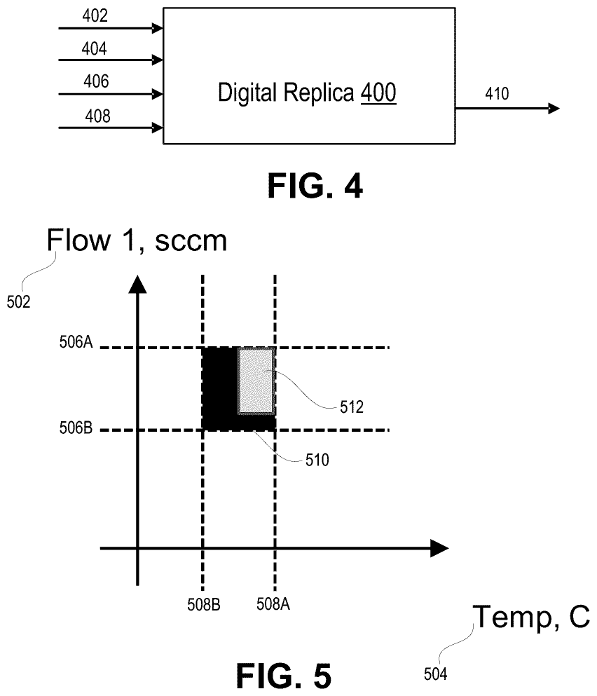

FIG. 4 depicts an exemplary digital replica, in accordance with some implementations of the present disclosure. A digital replica 400 may include a digital twin of a selection of a fabrication system, and may include, for example, a digital reproduction of the fabrication system that includes the same chambers, valves, gas delivery lines, materials, chamber components, and so on. A digital replica 400 can receive as input manufacturing equipment processing data, which may include first sensor data 402-404 output by integral sensors of a process chamber and second sensor data 406-408 output by external sensors that are not components of the process chamber. The input may further include process recipes and/or output physical conditions of a manufacturing system that includes the process chamber. In some embodiments, the digital replica 400 includes a physics based model that can incorporate various physics relationships such as thermodynamics, fluid dynamics, energy conservation, gas laws, mechanical system, energy conservation, transportation, and deliver, and so on. The digital replica 400 processes the input data, and generates an output 410. The output may include one or more physical conditions of a process chamber and/or other system or device. The output may additionally or alternatively include environmental resource usage data.

In an example, the digital replica 400 may receive as input a first gas flow of a first gas, a second gas flow of a second gas, and a third gas flow of a third gas, and a first process recipe. The digital replica may use a physics based model to estimate the amount of energy leaving the chamber by the gas flow. For example, the model determines a temperature of exhaust and total energy flow through the exhaust. In another example the same digital replica 400 may output predicted eco-efficiency data such as predicted consumption of environmental resources. The digital replica may identify relevant consumption of resources and identify suggested optimizations to improve energy conservation.

In some embodiments, digital replica 400 can determine exhaust for one or more gas panel or gas boxes that contain gases used in one or more places throughout a fabrication system. For example, each gas box may use a dedicated exhaust with a negative pressure to effectively evacuate gases such as in the case of leak or more generally malfunctions of the gas lines (e.g., to keep toxins from entering the fabrication facility or in undesired locations of the fabrication system. The digital replica may be part of a digital twin that leverages information about possible types and volumes of gases of the gas box and determine adjustments to exhaust flow needed to properly dispose of the gases (e.g., evacuate leaks). The evacuation flow rate may be determined in view of an exhaust pressure and a flow. The evacuation flow may include a determination of an associated parameter to optimize eco-efficiency while maintaining a minimum safety threshold and/or standard.

In some embodiments, digital replica 400 may indicate a temperature of exhaust and total energy flow through exhaust based on heating within the process chamber. For example, a process chamber may include one or more process equipment such as a substrate pedestal during a substrate process procedure. Excess heat from within the chamber may be abated through exhaust. Operations of the pedestal may be altered to reduce the heat lost through exhaust. There are several methods reported to control heat transfer in heat transfer assemblies such as a pedestal for supporting a substrate including both a heating element and a cooling element which removes excess heat by circulating a cooling medium such as a gaseous or liquid coolant inside the pedestal or between the substrate and the pedestal When the substrate temperature increases beyond a set range during processes, the heating element is turned off, and the cooling element is activated to remove excess heat, thus controlling the temperature. One or more parameters associated with this process may be used as input to digital replica 400 to determine how much excess heat is lost through exhaust.

In some embodiments, digital replica 400 may indicate energy flow and/or chemicals including lost precursors or by-products of reaction exiting an abatement or scrubber system. For example, gaseous effluent streams from the manufacturing of electronic materials, devices, products, solar cells and memory articles (hereinafter “electronic devices”) may involve a wide variety of chemical compounds, organic compounds, oxidizers, breakdown products of photo-resist and other reagents, as well as other gases and suspended particulates that may be desirably removed from the effluent streams before the effluent streams are vented from a process facility into the atmosphere.

Effluent streams to be abated may include species generated by an electronic device manufacturing process and/or species that were delivered to the electronic device manufacturing process and which passed through the process chamber without chemical alteration. As used herein, the term “electronic manufacturing process” is intended to be broadly construed to include any and all processing and unit operations in the manufacture of electronic devices, as well as all operations involving treatment or processing of materials used in or produced by an electronic device and/or LCD manufacturing facility, as well as all operations carried out in connection with the electronic device and/or LCD manufacturing facility not involving active manufacturing (examples include conditioning of process equipment, purging of chemical delivery lines in preparation of operation, etch cleaning of process tool chambers, abatement of toxic or hazardous gases from effluents produced by the electronic device and/or LCD manufacturing facility, etc.).

In some embodiments, the digital replica 400 accounts for exhaust flow of leaking gas or as a part of a cleaning procedure. For example, gases may be regularly flushed from manufacturing assets such as to increase the lifetime of the asset, improve the performance of the product, or prepare the product for a different function that prepared tasked to perform. The digital replica 400 may determine environmental consumption (e.g., energy consumption, gas consumption) associated with performing this purging procedure. For example, the digital replica 400 may indicate an energy and/or gas consumption used to flush a system (e.g., constantly provide gas flow to a system to maintain dynamic gas movement within the system). The digital replica 400 may indicate how energy and/or gas consumption is altered by adjusting one or more gas flow rates (e.g., purge gas) within the processing system.

In some embodiments, the digital replica 400 may leverage the process recipe and determine what gases are entering a processing chamber, what reactions are occurring on a substrate disposed within the processing chamber, what utilization of the gases occur with the substrate reactions, and so on. The digital replica 400 may further determine what gases and in what quantities remain after the reactions occur on the surface of the substrate. The digital replica 400 may further determine an amount and type of gases lost through abatement. The digital replica 400 may further determine what the end-byproduct of that is abated and the overall effect the end-byproduct has on the environment.

In some embodiments, one or more substrate processing procedures may demand consistent gas flow into and/or out of a processing chamber to process a substrate that meets target process result conditions. The substrate processing system may carry out a steady gas flow procedure by performing one or more flow-to-vent to flow-to-chamber transitions to reduce transient air flow from turning ON/OFF air flow to a chamber. For example, a first gas flow may be initialized and vented and once the gas flow has stabilized a steady flow of gas may be provided to a process chamber by directing the vented air into the chamber. The digital replica 400 may determine gas consumption as a result of this process (e.g., gas lost through venting). For example, the digital replica may identify transition time and a quantity of gas lost through venting the gas during a transient period of initializing or terminating flow of the gas. The digital replica may determine optimizations to the transition between venting of the gas and directing the gas into the chamber. Optimizing the transition time may reduce the gas lost through venting while identifying a time when the gas reaches a steady-state. In some embodiments, the transition cadence of the gas flow may be determine based on process results requirements. For example, a gas flow transition time may be determined (e.g., optimized) to include a flow rate that does not negatively impact a process result within a corresponding process chamber.

Digital replica 400 may be used for predicting eco-efficiency data associated with one or more operational states of physical assets of a fabrication system. In an example, digital replica 400 may receive data associated with one or more operational state of physical assets of a fabrication system. For example, the digital replica 400 may receive reduced power data, sleep mode data, shared operational mode data, and/or process recipe data indicating one or more processing procedure performed by a fabrication system represented by digital replica 400.

Energy saving may occur when one or more physical assets operate at various operating states during operational time and idle time. For example, during different operations of the fabrication process, various elements of sub-fab equipment may not be necessary and so may be placed in a sleep, idle, hibernation, or off state, dependent upon how soon the elements are likely to be needed. Examples of power saving low power states include an idle state, a sleep state, and a hibernate state. The primary differences between the three power saving states are duration and energy consumption. Deeper levels of idle mode energy savings, such as sleep or hibernate, necessitate longer periods of time to recover from energy savings modes to achieve full production without affecting the quality or yield of the fabrication process. Recovery of the process chambers and associated sub-fab equipment to best known method (BKM) temperatures and pressures can take seconds, minutes, or hours depending on the degree of deviation from BKM chamber conditions associated with the power saving state of the sub-fab equipment and process chamber. An idle state typically lasts for seconds, a sleep state typically lasts for minutes, and a hibernate state typically lasts for hours.

The digital replica 400 may identify one or more operational/power states of a physical asset of the manufacturing system and determine the effect of using that power state in a given scenario (e.g., system hardware architecture, subsystem hardware architecture, process one or more process recipes, performing certain scheduled processes, and the like). For example, the digital replica 400 may be part of a digital twin that determines the effect of such power states and scenarios for idle or full power or modulations before actually implementing the power adjustment(s) on the manufacturing system.

A process tool and associated manufacturing system may have a variety of different power configurations based upon operating needs. For example, power configurations may exist where the process tool is in an “off” state while various air flow and abatement systems are operating at full capacity to perform shut down operations after completing a fabrication operation. For the purposes of this application, the term “low power configuration” refers to any state where one or more elements of the process tool and/or manufacturing system sub-fabs are instructed by one or more controllers to operate in a power-savings mode, such as different levels of energy consumption during specific process recipe operations or non-production idle modes of operation such as idle, sleep, and hibernate states described above, or an off state.

In some embodiments, one or more support assets may provide support functionality to more than one other physical assets. For example, the pumping of two process chambers may be performed by a single pump. Leveraging a support asset to alternate operations between two physical assets may reduce energy and overall environmental cost.

The digital replica 400 may predict environmental resource consumption data associated with one or more physical assets operating in one or more corresponding operational modes. The digital replica 400 may provide recommendations for a reduction in environmental consumption costs by recommending one or more physical assets leverage a reduced power state, a sleep mode state a hibernate state, and/or a shared operation mode data during a period of the corresponding tool experiences an idle state or a state when the demands of the physical asset low.

In another example, digital replica 400 may be configured for determining eco-efficiency data associated with performing preventative maintenance (PM) and/or cleaning of a physical asset of a fabrication system. Digital replica 400 may receive purge gas data, cleaning process data, preventative maintenance data, chamber recovery data, and/or a process recipe to determine environmental resource consumption.

Substrate processing may include a series of processes that produces electrical circuits in a semiconductor, e.g., a silicon wafer, in accordance with a circuit design. These processes may be carried out in a series of chambers. Successful operation of a modern semiconductor fabrication facility may aim to facilitate a steady stream of wafers to be moved from one chamber to another in the course of forming electrical circuits in the wafer. In the process of performing many substrate procedures, conditions of processing chambers may depreciate and result in processed substrates failing to meet desired conditions or process results (e.g., critical dimensions, process uniformity, thickness dimensions, etc.).

Cleaning process data may indicate one or more parameters associated with a cleaning process such as a cleaning duration, frequency, and/or etchant flows. A cleaning process may utilize certain environmental resources such as cleaning material, precursors, etchants, and/or other substances leveraged to carry out a cleaning procedure. For example, a cleaning procedure may be performed at a cadence or frequency (e.g., after a quantity of processed wafers) for a process results of future substrate to meet threshold conditions (e.g., process uniformity, critical dimensions, etc.). The frequency of process chamber cleaning can be adjusted (e.g., optimized) to identify a cleaning frequency that still results of substrates processed by the chamber operating under this clean frequency schedule to meet a threshold condition (e.g., minimum process result requirements). For example, a multi-wafer cleaning procedure may be implemented that saves environmental resources such as cleaning materials, precursors, etchants, and/or other substances leveraged to carry out a cleaning procedure. The digital replica 400 may receive cleaning data and determine cleaning optimization such as updates to cleaning duration, frequency, quantity of cleaning agent used, etc.

Preventative maintenance data indicates one or more of a type, frequency, duration, etc. of one or more preventative maintenance procedures associated with one or more physical assets of a fabrication system. Preventative maintenance procedures (e.g., chamber cleaning) are often used as part of a chamber recovery process to return a state of the processing chamber into a state suitable for entering a substrate processing production mode (e.g., mass processing of substrates). A recovery procedure is often used subsequent to a preventative maintenance procedure to prepare a chamber for the production mode (e.g., “warm up” the chamber).

Chamber recovery data indicates one or more of a type, frequency, duration, etc. of one or more chamber recovery procedures associated with one or more physical assets of a fabrication system. A common recovery procedure conventionally employed is seasoning a processing chamber. Chamber seasoning is a procedure that includes processing a series of substrates (e.g., blank silicon wafers) to restore a chamber condition (e.g., coating the walls of the chamber) that is suitable for a production substrate process (e.g., substrates processed in the chamber having process results that meet desired threshold criteria). After chamber seasoning, a chamber may operate in a production mode for a period of time until another round of preventative maintenance and further chamber seasoning is needed or otherwise recommended to restore a state of the processing chamber.

Purge gas data may indicate a type, quantity, frequency flow rate, cleaning duration of a purge gas. The digital replica may determine effects of altering one or more operational parameters related to an employed purge gas. For example, the digital replica 400 may predict updates to environmental resource consumption based on switching to a purging procedure using alternative purge gas types such as H₂, N₂, clean dry air (CDA), and the like.

In another example, digital replica 400 may be configured for determining eco-efficiency data associated with one or more operational states of physical assets of a fabrication system. Digital replica 400 may receive coolant loop configuration data, process chilled water (PCW) data, ambient air data, and/or process recipe and determine environmental resource consumption data therefrom.

Process chambers utilized in substrate processing typically comprise a number of internal components that are repeatedly heated and cooled during and after processes are performed. In some instances, for example, when routine service or maintenance is needed after a process has been performed in a process chamber, the components are cooled to about room temperature. In temperature controlled components, for example, such as process chamber showerheads having coolants channels, to cool the component from a typical operating temperature (e.g. about 90 degrees Celsius), a heat source that heats the component may be shut off and a coolant is flowed through the coolant channels to extract heat from the component.

Coolant loop configuration data indicates one or more geometries of one or more coolant loops configures to extract heat from one or more physical assets of a fabrication system. The one or more coolant loops may operate in parallel having multiple loops cool common regions of physical assets. The one or more coolant loops may cool multiple physical assets in series on with another. Process chilled water (PCW) data indicates one or more parameters of a coolant substance such as a type, flow rate, temperature, of coolant (e.g., process chilled water (PCW). The digital replica may include heat flow model that indicates where energy is transferred within an environment of a fabrication system leveraging one or more coolant loops. The digital replica 400 may identify a modification of a physical asset (e.g., a chamber, chamber wall, chamber system) that directs heat to a cooling loop and associated eco-efficiency saved by directing the heat to the cooling loops. Digital replica 400 may further determine effects of process results as PCW modulation occurs. PCW modulation may involves altering a flow rate within a cooling loop to alter a heat exchange within a physical asset of the fabrication system.

FIG. 5 is an exemplary illustration of an operational parameter limitation 500 for a fabrication process operation, in accordance with some implementation of the present disclosure. Various fabrication process operations may include operational parameter limitations 500 that indicate a process parameter window 510 or set of values (e.g., a combination of values) to a set of corresponding parameters that when satisfied attain a result that meets threshold condition (e.g., a minimum quality condition, a target condition, etc.). For example, a process parameter window 510 may include a first parameter 502 (e.g., a first flow rate of a first gas) and a second parameter 504 (e.g., temperature of the gas). To perform a fabrication process and meet a threshold condition (e.g., minimum quality standard, statistical process control (SPC) limit, specification limitations, substrate process target, etc.), a process parameter value window 510 is determined that identifies parameter value combinations that result in a product likely to meet the threshold condition. As shown in FIG. 5, the process parameter window 510 includes a lower limit 506A and a higher limit 506A to the first parameter 502 as well as a lower limit 508B and an upper limit 508A to the second parameter.

Optimizations identified by the manufacturing process system (e.g., using recommendation 284, data analyzer 266, etc.) may include determining an eco-optimized process parameter window 512 within the process parameter window 510 that causes a manufacturing operation to consume a reduced amount of resources as compared to process parameter values outside of the eco-optimized process parameter window 512.

It should be noted that FIG. 5 depicts a simplified process parameter window 510 and eco-optimized process parameter window 512 dependent on only two parameters 502, 504. The process parameter window 510 and eco-optimized process parameter window 512 both form simple rectangles. A process parameter window may include more than two parameters and can include more diverse parameter dependencies. For example, a non-linear, physics based, statistical, and/or empirical relationship between parameters may cause non-linear process parameter windows and eco-optimized process parameter windows.

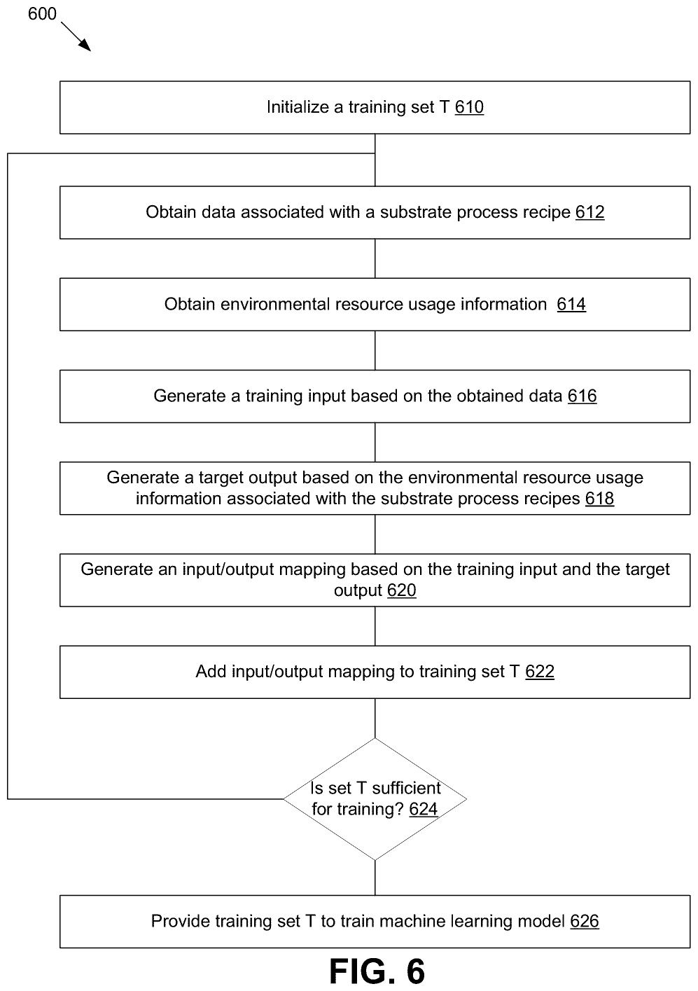

FIG. 6 is a flow chart of a method 600 for generating a training dataset for training a machine learning model to perform cooling parameter assessments, according to aspects of the present disclosure. Method 600 is performed by processing logic that can include hardware (circuitry, dedicated logic, etc.), software (such as is run on a general purpose computer system or a dedicated machine), firmware, or some combination thereof. In one implementation, method 600 can be performed by a computer system, such as computer system architecture 300 of FIG. 3. In other or similar implementations, one or more operations of method 600 can be performed by one or more other machines not depicted in the figures. In some aspects, one or more operations of method 600 can be performed by data set generator 374 of machine learning system 370, described with respect to FIG. 3.

For simplicity of explanation, method 600 is depicted and described as a series of operations. However, operations in accordance with this disclosure can occur in various orders and/or concurrently and with other operations not presented and described herein. Furthermore, not all illustrated operations may be performed to implement method 600 in accordance with the disclosed subject matter. In addition, those skilled in the art will understand and appreciate that method 600 could alternatively be represented as a series of interrelated states via a state diagram or events.

At block 610, processing logic initializes a training set T to an empty set (e.g., { }). At block 612, processing logic obtains substrate process recipe data (e.g., process recipe setpoint data, process knob setpoint data, process pressure setpoint data, process temperature setpoint data, etc.) associated with processing a substrate at a processing chamber of a manufacturing system. The process recipe data may include and/or make up historical process recipe data (e.g., recipe data collected over time). In some embodiments, processing logic further obtains sensor data (e.g., temperature sensor data, pressure sensor data, energy sensor data, etc.) and/or predicted sensor data (e.g., output from one or more additional models) associated with processing a substrate at a processing chamber in accordance with the process recipe and/or in accordance with other process recipes

At block 614, processing logic obtains environmental resource usage information. The environmental resource usage information may include information associated with consumption of resources such as chemical precursor, gas, water, energy, or the like, etc. The environmental resource usage information may include and/or make up historical environmental resource usage information (e.g., historical consumption data, etc.).

At block 616, processing logic generates a training input based on the process recipe data and/or the sensor data obtained at block 612. In some embodiments, the training input can include a normalized set of recipe data.

At block 618, processing logic can generate a target output based on the environmental resource usage information obtained at block 614. The target output can correspond to environmental resource usage metrics (data indicative of resource consumption) of a process recipe performed in the processing chamber.

At block 620, processing logic generates an input/output mapping. The input/output mapping refers to the training input that includes or is based on process recipe data, and the target output for the training input, where the target output identifies predicted environmental resource consumption, and where the training input is associated with (or mapped to) the target output. At block 622, processing logic adds the input/output mapping to the training set T.

At block 624, processing logic determines whether the training set, T, includes a sufficient amount of training data to train a machine learning model. It should be noted that in some implementations, the sufficiency of training set T can be determined based simply on the number of input/output mappings in the training set, while in some other implementations, the sufficiency of training set T can be determined based on one or more other criteria (e.g., a measure of diversity of the training examples, etc.) in addition to, or instead of, the number of input/output mappings. Responsive to determining the training set, T, includes a sufficient amount of training data to train the machine learning model, processing logic provides the training set, T, to train the machine learning model. Responsive to determining the training set does not include a sufficient amount of training data to train the machine learning model, method 600 returns to block 612.

At block 626, processing logic provides the training set T to train the machine learning model. In some embodiments, the training set T is provided to training engine 382 of machine learning system 370 and/or server machine 392 to perform the training. In the case of a neural network, for example, input values of a given input/output mapping (e.g., recipe data and/or cooling parameter data) are input to the neural network, and output values of the input/output mapping are stored in the output nodes of the neural network. The connection weights, layers, and/or hyperparameters in the neural network are then adjusted in accordance with a learning algorithm (e.g., backpropagation, etc.), and the procedure is repeated for the other input/output mappings in the training set T. After block 626, machine learning model 390 can be used to provide predicted environmental resource usage (e.g., predicted data indicative of resource consumption) for process recipe operations performed in the processing chamber.

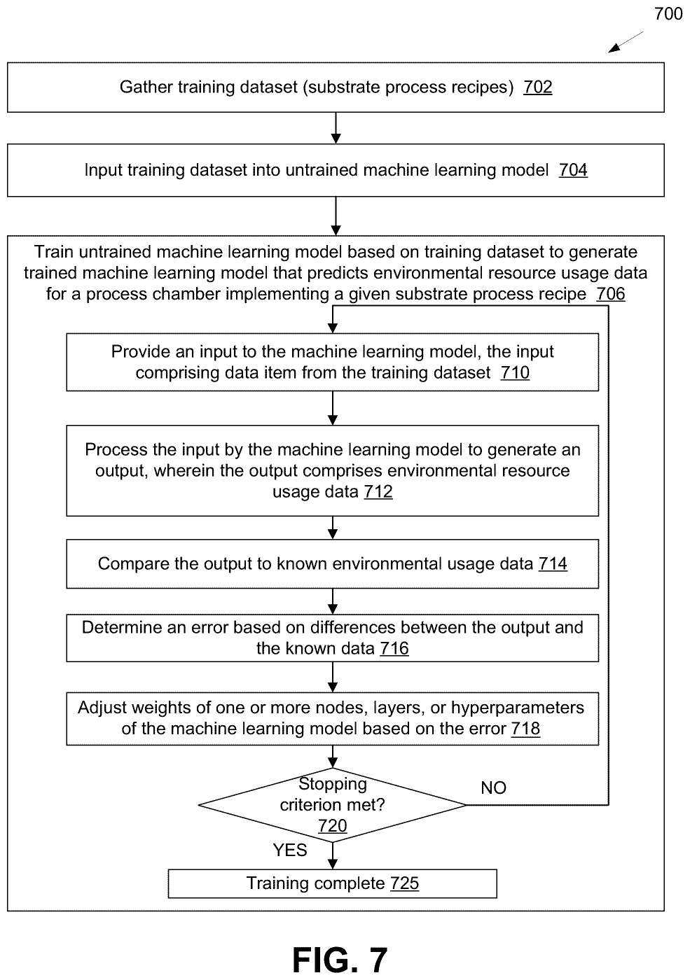

FIG. 7 is a flow chart illustrating an embodiment for a method 700 of training a machine learning model to estimate cooling parameter values for process recipes performed in a processing chamber, according to aspects of the present disclosure. Method 700 is performed by processing logic that can include hardware (circuitry, dedicated logic, etc.), software (such as is run on a general purpose computer system or a dedicated machine), firmware, or some combination thereof. In one implementation, method 700 can be performed by a computer system, such as computer system architecture 300 of FIG. 3. In other or similar implementations, one or more operations of method 700 can be performed by one or more other machines not depicted in the figures. In some aspects, one or more operations of method 700 can be performed by training engine 382 of machine learning system 370, described with respect to FIG. 3.

For simplicity of explanation, method 700 is depicted and described as a series of operations. However, operations in accordance with this disclosure can occur in various orders and/or concurrently and with other operations not presented and described herein. Furthermore, not all illustrated operations may be performed to implement method 700 in accordance with the disclosed subject matter. In addition, those skilled in the art will understand and appreciate that method 700 could alternatively be represented as a series of interrelated states via a state diagram or events.

At block 702 of method 700, processing logic gathers a training dataset, which may include data from a plurality of substrate process recipes (e.g., process recipe setpoints, process control knob setpoints, etc.). The training dataset may further include sensor data associated with the performance of substrate process recipes. Each data item of the training dataset may include one or more labels. The data items in the training dataset may include input-level labels that indicate environmental resource usage associated with the substrate process recipe. For example, some data items may include a label of resource usage (e.g., usage of one or more resources such as chemical precursor, gas, energy, etc.) associated with the process recipe.

At block 704, data items from the training dataset are input into the untrained machine learning model. At block 706, the machine learning model is trained based on the training dataset to generate a trained machine learning model estimates environmental resource usage (e.g., consumption of resources, etc.) for processing a substrate in a processing chamber according to the process recipe. The machine learning model may also be trained to output one or more other types of predictions, classifications, decisions, and so on.

In one embodiment, at block 710 an input of a training data item is input into the machine learning model. The input may include substrate process recipe data (e.g., a substrate process recipe) indicating one or more process recipe setpoints. The data may be input as a feature vector in some embodiments. At block 712, the machine learning model processes the input to generate an output. The output may include environmental resource usage (e.g., consumption of one or more resources, etc.). The environmental resource usage may be estimated environmental resource usage for processing a substrate according to a process recipe.

At block 714, processing logic compares the output predicted environmental resource usage data to known environmental resource usage associated with the input. At block 716, processing logic determines an error based on differences between the output and the known environmental resource usage. At block 718, processing logic adjusts weights of one or more nodes in the machine learning model, one or more layers in the machine learning model, and/or one or more hyperparameters of the machine learning model based on the error.

At block 720, processing logic determines if a stopping criterion is met. If a stopping criterion has not been met, the method returns to block 710, and another training data item is input into the machine learning model. If a stopping criterion is met, the method proceeds to block 725, and training of the machine learning model is complete.

In one embodiment, one or more ML models are trained for application across multiple processing chambers, which may be a same type or model of processing chamber. A trained ML model may then be further tuned for use for a particular instance of a processing chamber. The further tuning may be performed by using additional training data items comprising substrate process recipes that can be performed in the processing chamber in question. Such tuning may account for chamber mismatch between chambers and/or specific hardware process kits of some processing chambers. Additionally, in some embodiments, further training is performed to tune an ML model for a processing chamber after maintenance on the processing chamber and/or one more changes to hardware of the processing chamber.

FIG. 8A is a flow diagram of a method 800A for obtaining a recommendation for processing a substrate, in accordance with some implementations of the present disclosure. Method 800A is performed by processing logic that can include hardware (circuitry, dedicated logic, etc.), software (such as is run on a general purpose computer system or a dedicated machine), firmware, or some combination thereof. In one implementation, method 800A can be performed by a computer system, such as computer system architecture 300 of FIG. 3. In other or similar implementations, one or more operations of method 800A can be performed by one or more other machines not depicted in the figures. In some embodiments, one or more operations of method 800A can be performed by eco-efficiency module 129 described with respect to FIG. 1. In some aspects, one or more operations of method 800A can be performed by one or more components of server 320, described with respect to FIG. 3.

For simplicity of explanation, method 800A is depicted and described as a series of operations. However, operations in accordance with this disclosure can occur in various orders and/or concurrently and with other operations not presented and described herein. Furthermore, not all illustrated operations may be performed to implement method 800A in accordance with the disclosed subject matter. In addition, those skilled in the art will understand and appreciate that method 800A could alternatively be represented as a series of interrelated states via a state diagram or events.

At block 802, processing logic receives a process recipe that includes process recipe setpoint data. The process recipe may be for processing a substrate in a process chamber of a manufacturing system. In some embodiments, the processing logic receives multiple process recipes, each process recipe including recipe setpoint data. For example, a first set of process recipe setpoint data may indicate the setpoints of a first process recipe and a second set of process recipe setpoint data may indicate the setpoints of a second process recipe. The processing logic may receive both the first set and the second set of data. Similarly, a third set of process recipe setpoint data may indicate the setpoints of a third process recipe. The processing logic may receive the first set, the second set, and the third set. In some embodiments, the process recipe setpoint data includes predicted setpoint data output from a model (e.g., process model 262 of FIG. 2B) that is configured to predict recipe setpoint data based on an input process target. The recipe setpoint data may indicate one or more process recipes that can be performed (e.g., in a process chamber) to process a substrate that meets the process target.

Processing logic may optionally receive sensor data associated with substrate processing in the process chamber. In some embodiments, the sensor data indicates conditions (such as temperature, pressure, precursor flow, gas flow, etc.) in the process chamber during substrate processing. In some examples, the sensor data indicates conditions across the operating range of the processing chamber. The sensor data may be associated with the processing of a first substrate according to a first process recipe, a second substrate according to a second process recipe, and/or a third substrate according to a third process recipe, etc. In some embodiments, the sensor data indicates physical bounds of the process chamber conditions and/or process recipes performed in the process chamber. For example, the sensor data can indicate a normal range of conditions (e.g., normal temperature range, normal pressure range, etc.) inside the process chamber during substrate processing according to one or more process recipes.

At block 804, processing logic inputs the process recipe received at block 802 into one or more machine learning models. In some embodiments, the one or more machine learning models are trained to predict eco-efficiency data (e.g., chamber model 264 of FIG. 2B). In some embodiments, the one or more machine learning models are trained with training input data including historical process recipe data (e.g., recipe setpoint data, recipe setpoints, etc.) and training target output data including historical environmental resource usage data (e.g., resource consumption data, etc.).

In some embodiments, the one or more machine learning models includes a “chain” of machine learning models. For example, a first machine learning model may be trained to output first predicted data, and a second machine learning model may be trained using the first predicted data to output second predicted data. In some embodiments, a first machine learning model is trained with training input data including historical process recipes and training target output data including historical sensor data (e.g., historical sensor measurement data associated with substrate processing the process chamber). One or more process recipes may be input into the first machine learning model to obtain predicted measurements (e.g., predicted measurement data, predicted sensor measurement data, etc.) corresponding to the input process recipe at block 805A.

In some embodiments, a second machine learning model is trained with the predicted measurements output from the first machine learning model. The second machine learning model may be further trained with training input data including the historical process recipes and training output data including historical eco-efficiency data. The second machine learning model may be trained to output predicted eco-efficiency data (e.g., predicted environmental resource usage data). The one or more process recipes and the predicted measurements output from the first machine learning model may be input into the second machine learning model to determine the predicted environmental resource usage data at block 805B.

In some embodiments, multiple process recipes are input into the one or more machine learning models at block 804, each process recipe including a corresponding set of recipe setpoint data.

In some embodiments, the one or more trained machine learning models are trained to output predicted environmental resource usage data. The predicted environmental resource usage data may be indicative of an environmental resource consumption associated with processing the substrate in the processing chamber according to the process recipe. For example, the predicted environmental resource usage data may indicate the predicted consumption of one or more resources used for processing a substrate according to the process recipe. In some embodiments, the predicted environmental resource usage data indicates the consumption of a particular resource (e.g., chemical precursor, water, etc.) and/or the consumption of multiple resources. In some embodiments, the predicted environmental resource usage data includes multiple sets of environmental resource usage data. For example, the one or more trained machine learning models can output a set of environmental resource usage data for each corresponding process recipe input into the one or more models. In such an example, a set of environmental resource usage data may indicate that the corresponding process recipe is more eco-efficient than another process recipe. Specifically, the set of environmental resource usage data may indicate that the corresponding process recipe uses fewer resources to perform the recipe when compared with the other recipes input into the one or more models. In some examples, the one or more models output predicted first environmental resource usage data corresponding to a first process recipe and predicted second environmental resource usage data corresponding to a second process recipe. In some embodiments, the environmental resource usage data may include time series data from which resource consumption can be determined.

At block 808, processing logic determines a recommendation associated with processing the substrate according to the process recipe based on a comparison of predicted first environmental resource usage data and predicted second environmental usage data. In some embodiments, processing logic compares predicted resource consumption associated with the process recipe (e.g., indicated by first environmental resource usage data) with predicted resource consumption associated with another process recipe (e.g., indicated by second environmental resource usage data). The predicted resource consumption may indicate that one process recipe is more eco-efficient than the other. This may be determined by comparison. In some embodiments, the processing logic compares multiple sets of environmental resource usage data to determine a most eco-efficient process recipe. For example, processing logic may determine the most eco-efficient process recipe from a selection of multiple process recipes based on corresponding predicted (e.g., by the model) resource consumption.

In some embodiments, the recommendation indicates that the most eco-efficient process recipe is to be implemented for processing substrates to meet a process target (e.g., a processed substrate target, etc.). For example, the recommendation can be a selection of a predicted most eco-efficient process recipe selected from multiple process recipes (e.g., the setpoint data of which is received at block 802). In some embodiments, the recommendation indicates a modification to a process recipe to make the process recipe more eco-efficient. For example, the recommendation may indicate a change in recipe setpoints to reduce the resource consumption of the process recipe. In some examples, the processing logic can determine the modification using predicted resource consumption data corresponding to other process recipes. The recommendation may be to optimize the eco-efficiency of the process recipe by changing the recipe setpoints to more closely match another process recipe having a higher predicted eco-efficiency (e.g., indicated by lower predicted resource consumption).

At bock 810, processing logic outputs the recommendation associated with the process recipe. In some embodiments, the recommendation is output to a system controller for implementation in the processing of substrates. For example, the system controller may implement the process recipe (e.g., the most eco-efficient process recipe as a result of comparing) indicated by the recommendation for processing substrates in the process chamber. In another example, the system controller may modify the process recipe according to the recommendation to form a more eco-efficient process recipe and/or to make the process recipe more eco-efficient.

FIG. 8B is a flow diagram of a method 800B for obtaining predicted process recipe setpoint data, in accordance with some implementations of the present disclosure. Method 800B is performed by processing logic that can include hardware (circuitry, dedicated logic, etc.), software (such as is run on a general purpose computer system or a dedicated machine), firmware, or some combination thereof. In one implementation, method 800B can be performed by a computer system, such as computer system architecture 300 of FIG. 3. In other or similar implementations, one or more operations of method 800B can be performed by one or more other machines not depicted in the figures. In some embodiments, one or more operations of method 800B can be performed by eco-efficiency module 129 described with respect to FIG. 1. In some aspects, one or more operations of method 800B can be performed by one or more components of server 320, described with respect to FIG. 3. Method 800B is performed in connection with method 800A in some embodiments.

For simplicity of explanation, method 800B is depicted and described as a series of operations. However, operations in accordance with this disclosure can occur in various orders and/or concurrently and with other operations not presented and described herein. Furthermore, not all illustrated operations may be performed to implement method 800B in accordance with the disclosed subject matter. In addition, those skilled in the art will understand and appreciate that method 800B could alternatively be represented as a series of interrelated states via a state diagram or events.

At block 822, processing logic receives target data including a target substrate condition associated with a processed substrate. In some embodiments, the target condition indicates one or more features (e.g., surface features, coatings, etc.) of a target processed substrate. In some examples, the target substrate process data indicates a specification for processed substrates. The specification can indicate a threshold for acceptable processed substrates.

At block 824, processing logic inputs the target condition into a model (e.g., process model 262 of FIG. 2B). The model may include one or more additional models that are in addition to the model(s) described with respect to method 800A of FIG. 8A. In some embodiments, the model is an additional trained machine learning model. An additional machine learning model may be trained (to form the additional trained machine learning model) with training input including historical process target data including historic target conditions and training target output data including historical process recipes (e.g., including historical process recipe setpoint data). In some examples, the historical target conditions include multiple historical target conditions. The historical conditions may indicate one or more historical features of historical target processed substrates. In some examples, the historical target conditions indicate historical specifications for historical processed substrates. The historical specifications may indicate historical thresholds for acceptable historical processed substrates. In some embodiments, the additional machine learning model is trained to output predicted process recipes associated with a process target input into the model. For example, a process target can be input into the additional trained machine learning model, and one or more predicted process recipes that produce a processed substrate meeting the process target are output from the model.

At block 826, processing logic receives, as output from the model, a first process recipe and a second process recipe. The first process recipe and/or the second process recipe may each correspond to the target substrate process data received at block 822. In some embodiments, the model outputs additional process recipes (e.g., additional sets of process recipe setpoint data). The process recipes output by the model may each produce a substrate meeting the target substrate condition when performed. For example, the model may output a first process recipe and a second process recipe. When a substrate is processed in a processing chamber according to either the first process recipe or the second process recipe, the processed substrate will meet the target condition indicated by the target condition. In some embodiments, one or more process recipes received at block 826 corresponds to a process recipe received at block 802 of method 800A.

FIG. 8C is a flow diagram of a method 800C for obtaining predicted process recipe setpoint data, in accordance with some implementations of the present disclosure. Method 800C is performed by processing logic that can include hardware (circuitry, dedicated logic, etc.), software (such as is run on a general purpose computer system or a dedicated machine), firmware, or some combination thereof. In one implementation, method 800C can be performed by a computer system, such as computer system architecture 300 of FIG. 3. In other or similar implementations, one or more operations of method 800C can be performed by one or more other machines not depicted in the figures. In some embodiments, one or more operations of method 800C can be performed by eco-efficiency module 129 described with respect to FIG. 1. In some aspects, one or more operations of method 800C can be performed by one or more components of server 320, described with respect to FIG. 3. Method 800C is performed in connection with method 800A in some embodiments.

For simplicity of explanation, method 800C is depicted and described as a series of operations. However, operations in accordance with this disclosure can occur in various orders and/or concurrently and with other operations not presented and described herein. Furthermore, not all illustrated operations may be performed to implement method 800C in accordance with the disclosed subject matter. In addition, those skilled in the art will understand and appreciate that method 800C could alternatively be represented as a series of interrelated states via a state diagram or events.

At block 832, processing logic trains a first machine learning model trained to output predicted measurement data based on a process recipe that is input into the first machine learning model. In some embodiments, the first machine learning model is a first model in a “chain” of machine learning models. The first machine learning model may be trained with training input data including historical process recipes (e.g., historical process recipe setpoint data). The first machine learning model may be further trained with training target output data including historical measurement data. The historical measurement data may include sensor data collected during processing of substrate in one or more process chambers. In some examples, the historical measurement data may include measurements of current, voltage, power, flow, pressure, concentration, speed, acceleration, and/or temperature. Similarly, the predicted measurement data that the first machine learning model is trained to output may include predicted measurements of current, voltage, power, flow, pressure, concentration, speed, acceleration, and/or temperature. In some embodiments, the predicted measurements include predicted time series data of the measurements.

At block 834, processing logic trains a second machine learning model to output predicted environmental resource usage data (e.g., predicted eco-efficiency data). In some embodiments, the second machine learning model is a second model in the “chain” of machine learning models. In some embodiments, the second machine learning model is trained with training input data including the predicted measurement data output from the first machine learning model. In some embodiments, the second machine learning model is trained with predicted time-series measurements output from the first machine learning model. The training input data may further include the historical process recipes used to train the first machine learning model. In some embodiments, the second machine learning model is trained with training target output data including historical environmental resource usage data (e.g., historical eco-efficiency data). Training the second machine learning model using the output of the first machine learning model may increase the accuracy of the predicted environmental resource data output by the second machine learning model. In some examples, using an intermediate output from the first machine learning model (e.g., the predicted measurement data) to train the second machine learning model can provide heightened accuracy for the final output from the second machine learning model (e.g., the predicted environmental resource usage data) when compared to predicting the final output using a single model. In some embodiments, the first machine learning model is representative of process chamber behavior that closely tracks changes in process recipe setpoints, while the second machine learning model is additionally representative of process chamber behavior that does not closely track changes in process recipe setpoints.

Optionally, in some embodiments, processing logic trains a third machine learning model to output further predicted environmental resource usage data (e.g., further predicted eco-efficiency data). In some embodiments, the third machine learning model is a third model in the “chain” of machine learning models. In some embodiments, the third machine learning model is trained with training input data including the predicted measurement data output from the first machine learning model. In some embodiments, the third machine learning model is trained with predicted time-series measurements output from the first machine learning model. The training input data may further include the historical process recipes used to train the first machine learning model. In some embodiments, the third machine learning model is trained with training target output data including historical environmental resource usage data (e.g., historical eco-efficiency data) and predicted environmental resource usage data output from the second machine learning model. Training the second machine learning model using the output of the first machine learning model and/or the output of the second machine learning model may increase the accuracy of the predicted environmental resource data output by the third machine learning model (e.g., the further predicted environmental resource data output by the third machine learning model may be more accurate than the predicted environmental resource data output by the second machine learning model).

At block 836, processing logic inputs a process recipe (e.g., data indicative of a process recipe such as process recipe setpoints) into the second trained machine learning model. The second trained machine learning model may predict environmental resource usage data based on (e.g., corresponding to) the process recipe.

At block 838, processing logic receives predicted environmental resource usage data output from the second machine learning model. In some embodiments, the environmental resource usage data is indicative of environmental resource consumption associated with processing a substrate according to the process recipe. In some embodiments, the predicted environmental resource usage data is time series data indicative of resource consumption over time. For example, the second machine learning model can predict power consumption of one or more components of a process chamber (e.g., a heater, etc.) when a substrate is processed according to the recipe input into the second machine learning model.

FIG. 9A illustrates a chart showing predicted environmental resource consumption data with respect to observed environmental resource consumption, in accordance with some implementations of the present disclosure. The chart illustrated in FIG. 9A may show predicted environmental resource consumption from a regression model (e.g., a trained machine learning model using one or more regression methods). In some embodiments, the predicted environmental resource consumption for a particular process recipe lies within a threshold bounded by upper bound 912 and lower bound 914. A data point 908 (of which several are shown) may represent predicted resource consumption (e.g., via one or more trained machine learning models as described herein) versus actual observed resource consumption. Where predicted resource consumption matches actual resource consumption, the data point will lie on dashed line 910, meaning the predicted resource consumption and the actual resource consumption are equal. Where the data point lies within the threshold bounded by 914 and 912, the one or more machine learning models described herein may have sufficient accuracy to predict environmental resource consumption. In some embodiments, a particular process recipe may have variations between performances even when performed in the same processing chamber. Therefore, the predicted environmental resource consumption may correspond to a likely average environmental resource consumption.

FIG. 9B illustrates a chart showing predicted and actual time series environmental resource consumption data 950, in accordance with some implementations of the present disclosure. Solid line 952 may represent actual resource consumption data and dashed line 954 may represent predicted resource consumption data. In some embodiments, predicted time series environmental resource consumption data corresponding to dashed line 954 is output from a trained machine learning model. In some embodiments, the trained machine learning model (e.g., one or more trained machine learning models, multiple trained machine learning models that are “daisy-chained,” etc.) is trained with actual resource consumption data, such as represented by solid line 952. In some embodiments, physical constraints are used to inform the trained machine learning model. An additional machine learning model may predict additional resource consumption data based on predicted time series environmental resource consumption data represented by dashed line 954. The consumption data may be predicted based on various inputs such as a substrate target, a process recipe, and/or historical training data. In some embodiments, eco-efficiency can be determined using the time series environmental resource consumption data 950. For example, where energy consumption is represented in the data 950, total energy and/or power consumption over time for a process recipe can be calculated (e.g., the area under the curve, etc.) and eco-efficiency data can be determined from energy and/or power consumption.

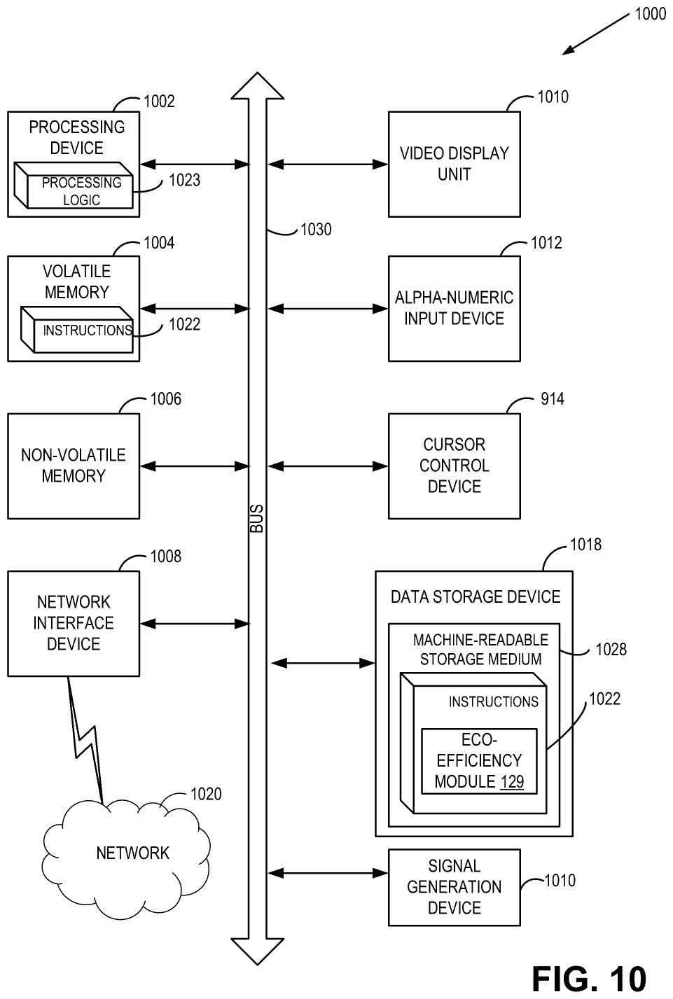

FIG. 10 depicts a block diagram of an example computing device, operating in accordance with one or more aspects of the present disclosure. In various illustrative examples, various components of the computing device 1000 may represent various components of the system controller 128, computing device 250, device executing web client 220, and so on.

Example computing device 1000 may be connected to other computer devices in a LAN, an intranet, an extranet, and/or the Internet (e.g., using a cloud environment, cloud technology, and/or edge computing). Computing device 1000 may operate in the capacity of a server in a client-server network environment. Computing device 1000 may be a personal computer (PC), a set-top box (STB), a server, a network router, switch or bridge, or any device capable of executing a set of instructions (sequential or otherwise) that specify actions to be taken by that device. Further, while only a single example computing device is illustrated, the term “computer” shall also be taken to include any collection of computers that individually or jointly execute a set (or multiple sets) of instructions to perform any one or more of the methods discussed herein.

Example computing device 1000 may include a processing device 1002 (also referred to as a processor or CPU), a main memory 1004 (e.g., read-only memory (ROM), flash memory, dynamic random access memory (DRAM) such as synchronous DRAM (SDRAM), etc.), a static memory 1006 (e.g., flash memory, static random access memory (SRAM), etc.), and a secondary memory (e.g., a data storage device 1018), which may communicate with each other via a bus 1030.

Processing device 1002 represents one or more general-purpose processing devices such as a microprocessor, central processing unit, or the like. More particularly, processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 1002 may be configured to execute instructions implementing methods 600-800B illustrated in FIGS. 6-8B.

Example computing device 1000 may further comprise a network interface device 1008, which may be communicatively coupled to a network 1020. Example computing device 1000 may further comprise a video display 1010 (e.g., a liquid crystal display (LCD), a touch screen, or a cathode ray tube (CRT)), an alphanumeric input device 1012 (e.g., a keyboard), a cursor control device 1014 (e.g., a mouse), and an acoustic signal generation device 1016 (e.g., a speaker).

Data storage device 1018 may include a machine-readable storage medium (or, more specifically, a non-transitory machine-readable storage medium) 1028 on which is stored one or more sets of executable instructions 1022. For example the data storage may be physical storage on-premise or remote such as a cloud storage environment. In accordance with one or more aspects of the present disclosure, executable instructions 1022 may comprise executable instructions associated with executing method 800A of FIG. 8A and/or method 800B of FIG. 8B. In one embodiment, instructions 1022 include instructions for eco-efficiency module 129 of FIG. 1.

Executable instructions 1022 may also reside, completely or at least partially, within main memory 1004 and/or within processing device 1002 during execution thereof by example computing device 1000, main memory 1004 and processing device 1002 also constituting computer-readable storage media. Executable instructions 1022 may further be transmitted or received over a network via network interface device 1008.

While the computer-readable storage medium 1028 is shown in FIG. 10 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “providing,” “determining,” “storing,” “adjusting,” “causing,” “receiving,” “comparing,” “creating,” “stopping,” “loading,” “copying,” “throwing,” “replacing,” “performing,” “outputting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, compact disc read only memory (CD-ROMs), and magnetic-optical disks, read-only memories (ROMs), random access memories (RAMs), erasable programmable read-only memory (EPROMs), electrically erasable programmable read-only memory (EEPROMs), magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method operations. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method comprising:
receiving a first process recipe comprising first process recipe setpoint data;
inputting the first process recipe into one or more trained machine learning models that output predicted first environmental resource usage data indicative of a first environmental resource consumption associated with processing a substrate in a process chamber according to the first process recipe; and
outputting a recommendation associated with the first process recipe based at least in part on the predicted first environmental resource usage data.

2. The method of claim 1, further comprising:
determining the recommendation based on a comparison of the predicted first environmental resource usage data and a predicted second environmental resource usage data, wherein the predicted second environmental resource usage data is indicative of a second environmental resource consumption associated with processing the substrate in the process chamber according to a second process recipe.

3. The method of claim 2, further comprising:
receiving target data comprising a target substrate condition for a processed substrate;
inputting the target data into one or more additional models; and
receiving, as output from the one or more additional models, the first process recipe and the second process recipe.

4. The method of claim 3, wherein the one or more additional models comprise a second trained machine learning model.

5. The method of claim 3, further comprising:
predicting, via a first additional model of the one or more additional models, one or more first measurements corresponding to the first process recipe; and
predicting, via a second additional model of the one or more additional models, one or more second measurements based on the first process recipe and the one or more first measurements output from the first additional model.

6. The method of claim 5, wherein the one or more first measurements and the one or more second measurements comprise predicted measurements of at least one of current, voltage, power, flow, pressure, concentration, speed, acceleration, or temperature.

7. The method of claim 1, wherein the predicted first environmental resource usage data comprises predicted time series data associated with a predicted behavior of the process chamber during execution of the first process recipe.

8. The method of claim 1, wherein the recommendation comprises a modification to the first process recipe to form a modified first process recipe, and wherein processing the substrate according to the modified first process recipe has a reduced environmental resource consumption compared to processing the substrate according to the first process recipe.

9. The method of claim 1, wherein the environmental resource usage data comprises time series data for at least one of an energy consumption, a gas consumption, or a water consumption associated with substrate processing in the process chamber.

10. A system comprising:
one or more process chambers configured to process substrates, the one or more process chambers comprising a plurality of sensors; and
a system controller to control the one or more process chambers, wherein the system controller is to:
receive a first process recipe comprising first process recipe setpoint data;
input the first process recipe into one or more trained machine learning models that output predicted first environmental resource usage data indicative of a first environmental resource consumption associated with processing a substrate in a first process chamber according to the first process recipe; and
output a recommendation associated with the first process recipe based at least in part on the predicted first environmental resource usage data.

11. The system of claim 10, wherein the system controller is further to:
determine the recommendation based on a comparison of the predicted first environmental resource usage data and a predicted second environmental resource usage data, wherein the predicted second environmental resource usage data is indicative of a second environmental resource consumption associated with processing the substrate in the first process chamber according to a second process recipe.

12. The system of claim 11, wherein the system controller is further to:
receive target data comprising a target substrate condition for a processed substrate;
input the target data into one or more additional models; and
receive, as output from the one or more additional models, the first process recipe and the second process recipe.

13. The system of claim 12, wherein the one or more additional models comprise a second trained machine learning model.

14. The system of claim 12, wherein the system controller is further to:
predict, via a first additional model of the one or more additional models, one or more first measurements corresponding to the first process recipe; and
predict, via a second additional model of the one or more additional models, one or more second measurements based on the first process recipe and the one or more first measurements output from the first additional model.

15. The system of claim 10, wherein the recommendation comprises a modification to the first process recipe to form a modified first process recipe, and wherein processing the substrate according to the modified first process recipe has a reduced environmental resource consumption compared to processing the substrate according to the first process recipe.

16. A non-transitory machine-readable storage medium comprising instructions that, when executed by a processing device, cause the processing device to:
train a first machine learning model to form a first trained machine learning model, wherein the first trained machine learning model is trained to output predicted measurement data based on a process recipe input into the first trained machine learning model; and
train a second machine learning model with training data comprising the predicted measurement data output from the first trained machine learning model to form a second trained machine learning model, wherein the second trained machine learning model is trained to output predicted first environmental resource usage data indicative of an environmental resource consumption associated with processing a substrate in a process chamber according to the process recipe input into the second trained machine learning model.

17. The non-transitory machine-readable storage medium of claim 16, wherein the processing device is further to:
train a third machine learning model with training data comprising the predicted measurement data output from the first trained machine learning model and the predicted first environmental resource usage data output from the second machine learning model to form a third trained machine learning model, wherein the third machine learning model is trained to output predicted second environmental resource usage data indicative of the environmental resource consumption associated with processing a substrate in a process chamber according to the process recipe input into the third trained machine learning model.

18. The non-transitory machine-readable storage medium of claim 16, wherein the processing device is further to:
train an additional machine learning model with training input data comprising historical process target data and training target output data comprising historical process recipes to form an additional trained machine learning model, wherein the additional trained machine learning model is trained to output one or more predicted process recipes associated with a process target input into the additional trained machine learning model.

19. The non-transitory machine-readable storage medium of claim 16, wherein the processing device is further to:
receive measurement data associated with a plurality of process recipes, wherein the measurement data comprises measurement of at least one of current, voltage, power, flow, pressure, concentration, speed, acceleration, or temperature;
receive environmental resource usage data corresponding to the plurality of process recipes, wherein the environmental resource usage data is indicative of environmental resource consumption associated with the plurality of process recipes; and
train one or more of the first machine learning model or the second machine learning model with one or more of the measurement data or the environmental resource usage data.

20. The non-transitory machine-readable storage medium of claim 16, wherein the processing device is further to:
receive a first process recipe comprising first process recipe setpoint data;
input the first process recipe into the second trained machine learning model; and
output a recommendation associated with the first process recipe based at least in part on predicted first environmental resource usage data associated with the first process recipe.
